(19) United States
(12) Patent Application Publication
(10) Pub. No.: US 2013/0208928 A1
(43) Pub. Date: Aug. 15, 2013

(54) AUDIO PROCESSING APPARATUS

(71) Applicant: Onkyo Corporation, (US)

(72) Inventor: Tadaharu SUNAGA, Osaka (JP)

(73) Assignee: ONKYO CORPORATION, Osaka (JP)

(21) Appl. No.: 13/751,715

(22) Filed: Jan. 28, 2013

(30) Foreign Application Priority Data
Feb. 10, 2012 (JP) 2012-26760

(51) Int. Cl. H04R 3/12

(52) U.S. Cl. CPC H04R 3/12
USPC 381/307

(57) ABSTRACT

A ZONE4 left audio signal Z4L is output without releasing a connection of a surround left speaker SSL. When determining that a playback of the ZONE4 left audio signal Z4L is set by a user manipulation, a controller 2 controls switches S11b and S13b in an on state, and controls switches S11a, S13a, and S13c in an off state. Accordingly, the ZONE4 left audio signal Z4L is supplied from a DSP to an amplifier 12a through the switch S11b, amplified by the amplifier 12a, and supplied to a surround back left/ZONE4 left SP terminal 14b through the switch S13b. A surround left SP terminal 14a is an output terminal dedicated to a surround left audio signal, so that the ZONE4 left audio signal Z4L can be output without releasing the connection of the surround left speaker SSL.

### BACKGROUND OF THE INVENTION

1. Field of the Invention

The present invention relates to an audio processing apparatus that plays back multichannel audio data.

2. Description of the Related Art

An audio playback system including a BD (Blue-ray disc) player, an AV amplifier, and a display device is used. Audio data transmitted from the BD player to the AV amplifier is generated by encoding multichannel audio data. For example, as illustrated in FIG. 4, the multichannel audio data includes a left audio signal L, a right audio signal R, a central audio signal C, a low-frequency audio signal SW, a surround left audio signal SL, and a surround right audio signal SR. Recently HD (High Definition)-related audio formats, such as Dolby True HD, Dolby Digital Plus, and DTS-HD, which are used in a BD player, appear on the scene. A surround back left audio signal SBL, a surround back right audio signal SBR, a left outside audio signal LW, a right outside audio signal RW, a left upside audio signal LH, and a right upside audio signal RH are further added in the HD-related audio formats.

However, when amplifiers corresponding to the audio signals of all the channels are provided in the AV amplifier, it is necessary to provide the amplifiers for the total of 11.1 channels, which results in a problem in that a cost increases significantly. The same holds true for the case that, as illustrated in FIG. 7, a left-central-side audio signal LC and a right-central-side audio signal RC are added instead of any one of the extended channels (or in addition to the extended channels). The same also holds true for the case that the AV amplifier generates the extended channels in a DSP according to a listening mode.

An audio processing apparatus in FIG. 15 is conceivable for the purpose of solving the problem. According to the audio processing apparatus, in the case that the surround back left audio signal SBL and the left upside audio signal LH are included, switches S511c and S511e are controlled in an on state, switches S511d, S511f, and S511g are controlled in an off state, the surround back left audio signal SBL is supplied from the DSP to an amplifier 512b through the switch S511c, and the left upside audio signal LH is supplied from the DSP to an amplifier 512c through the switch S511e. Switches S513b and S513e are controlled in the on state, and switches S513c and S513d are controlled in the off state. Therefore, the surround back left audio signal SBL amplified by the amplifier 512b is supplied to a surround back left SP terminal 514b, and the left upside audio signal LH amplified by the amplifier 512c is supplied to a left upside SP terminal 514d (see Japanese Unexamined Patent Publication Nos. 2011-229113 and 2010-183203).

In the case that the surround back left audio signal SBL and the left outside audio signal LW are included, the surround back left audio signal SBL is supplied from the DSP to the amplifier 512b through the switch S511c, and the left outside audio signal LW is supplied from the DSP to the amplifier 512c through the switch S511e. The switches S513b and S513d are controlled in the on state, and switches S513c and S513e are controlled in the off state. Therefore, the surround back left audio signal SBL amplified by the amplifier 512b is supplied to the surround back left SP terminal 514b, and the left outside audio signal LW amplified by the amplifier 512c is supplied to a left outside SP terminal 514c.

In the case that the left outside audio signal LW and the left upside audio signal LH are included, the left outside audio signal LW is supplied from the DSP to the amplifier 512b through the switch S511c, and the left upside audio signal LH is supplied from the DSP to the amplifier 512c through the switch S511e. The switches S513c and S513e are controlled in the on state, and the switches S513b and S513d are controlled in the off state. Therefore, the left outside audio signal LW amplified by the amplifier 512b is supplied to the left outside SP terminal 514c, and the left upside audio signal LH amplified by the amplifier 512c is supplied to the left upside SP terminal 514d.

The audio processing apparatus can output the audio signal to a speaker disposed in other pieces of room, such as ZONE2, ZONE3, and ZONE4. A speaker terminal for a ZONE2 left audio signal is also used as the left outside SP terminal 514c. In the case that the ZONE2 audio signal is output, the switch S511d is controlled in the on state, the switch S511c is controlled in the off state, and a ZONE2 left audio signal Z2L is supplied from the DSP to the amplifier 512b through the switch S511d. The switches S513b and S513d are controlled in the off state, and the switch S513c is controlled in the on state. Therefore, the ZONE2 left audio signal Z2L amplified by the amplifier 512b is supplied to the ZONE2 left SP terminal 514c through the switch S513c. Alternatively, in the case that the ZONE2 audio signal is output, the switch S511f is controlled in the on state, the switches S511e and S511g are controlled in the off state, and the ZONE2 left audio signal Z2L is supplied from the DSP to the amplifier 512c through the switch S511f. The switch S513d is controlled in the on state, and the switches S513c and S513e are controlled in the off state. Therefore, the ZONE2 left audio signal Z2L amplified by the amplifier 512c is supplied to the ZONE2 left SP terminal 514c through the switch S513d.

A speaker terminal for a ZONE3 left audio signal is also used as the left upside SP terminal 514d. In the case that the ZONE3 audio signal is output, the switch S511g is controlled in the on state, the switches S511e and S511f are controlled in the off state, and a ZONE3 left audio signal Z3L is supplied from the DSP to the amplifier 512c through the switch S511g. The switch S513e is controlled in the on state, and the switch S513d is controlled in the off state. Therefore, the ZONE3 left audio signal Z3L amplified by the amplifier 512c is supplied to the ZONE3 left SP terminal 514d through the switch S513e.

A speaker terminal for a ZONE4 left audio signal is also used as a surround left SP terminal 514a. In the case that the ZONE4 audio signal is output, a switch S511b is controlled in the on state, a switch S511a is controlled in the off state, and a ZONE4 left audio signal Z4L is supplied from the DSP to an amplifier 512a through the switch S511b. The ZONE4 left audio signal Z4L amplified by the amplifier 512a is supplied to the ZONE4 left SP terminal 514a through a switch S513a by controlling the switch S513a in the on state.

At this point, because the speaker terminal for the ZONE4 left audio signal is also used as the surround left SP terminal 514a, it is necessary to connect a ZONE4 left speaker to the ZONE4 left SP terminal 514a in the case that the ZONE4 audio signal is output. In this case, a surround left speaker cannot be connected to the speaker terminal 514a. Accordingly, in the case that the surround left audio signal SL is played back without playing back the ZONE4 audio signal, it is necessary to release the connection of the ZONE4 speaker to the speaker terminal 514a and to separately connect the surround left speaker, which results in a troublesome procedure. Because the surround left audio signal is frequently used, it is necessary to frequently reconnect the speaker in the case that the ZONE4 is used. The reason the speaker terminal for the ZONE4 left audio signal is also used as the surround left SP terminal 514a is that the ZONE2 audio signal, the ZONE3 audio signal, and the ZONE4 audio signal can simultaneously be played back.

FIG. 16 illustrates another audio processing apparatus. In the case that the surround back left audio signal SBL is included, a switch S611c is controlled in the on state, a switch S611d is controlled in the off state, and the surround back left audio signal SBL is supplied from the DSP to an amplifier 612b through the switch S611c. A switch S613c is controlled in the on state, and switches S613d and S613e are controlled in the off state. Therefore, the surround back left audio signal SBL amplified by the amplifier 612b is supplied to a surround back left SP terminal 614b (see Japanese Unexamined Patent Publication No. 2010-183203).

In the case that the left outside audio signal LW is included, the switch S611c is controlled in the on state, the switch S611d is controlled in the off state, and the left outside audio signal LW is supplied from the DSP to the amplifier 612b through the switch S611c. The switch S613d is controlled in the on state, and the switches S613c and S613e are controlled in the off state. Therefore, the left outside audio signal LW amplified by the amplifier 612b is supplied to a left outside SP terminal 614c.

In the case that the left upside audio signal LH is included, the switch S611c is controlled in the on state, and the switch S611d is controlled in the off state, and the left upside audio signal LH is supplied from the DSP to the amplifier 612b through the switch S611c. The switch S613e is controlled in the on state, and the switches S613c and S613d are controlled in the off state. Therefore, the left upside audio signal LH amplified by the amplifier 612b is supplied to a left upside SP terminal 614d.

The speaker terminal for the ZONE2 left audio signal is also used as the left outside SP terminal 614c. In the case that the ZONE2 audio signal is output, the switch S611d is controlled in the on state, the switch S611c is controlled in the off state, and the ZONE2 left audio signal Z2L is supplied from the DSP to the amplifier 612b through the switch S611d. The switch S613d is controlled in the on state, and the switches S613c and S613e are controlled in the off state. Therefore, the ZONE2 left audio signal Z2L amplified by the amplifier 612b is supplied to the ZONE2 left SP terminal 614c through the switch S613d.

The speaker terminal for the ZONE3 left audio signal is also used as the surround left SP terminal 614a. In the case that the ZONE3 audio signal is output, a switch S611b is controlled in the on state, a switch S611a is controlled in the off state, and a ZONE3 left audio signal Z3L is supplied from the DSP to an amplifier 612a through the switch S611b. A switch S613a is controlled in the on state. Therefore, the ZONE3 left audio signal Z3L amplified by the amplifier 612a is supplied to a ZONE3 left SP terminal 614a through the switch S613a.

At this point, because the speaker terminal for the ZONE3 left audio signal is also used as the surround left SP terminal 614a, it is necessary to connect a ZONE3 left speaker to the ZONE3 left SP terminal 614a in the case that the ZONE3 audio signal is output. In this case, the surround left speaker cannot be connected to the speaker terminal 614a. Accordingly, in the case that the surround left audio signal SL is played back without playing back the ZONE3 audio signal, it is necessary to release the connection of the ZONE3 speaker to the speaker terminal 614a and to separately connect the surround left speaker, which results in a troublesome procedure. Because the surround left audio signal is frequently used, it is necessary to frequently reconnect the speaker in the case that the ZONE3 is used. The reason the speaker terminal for the ZONE3 left audio signal is also used as the surround left SP terminal 614a is that the ZONE2 audio signal and the ZONE3 audio signal can simultaneously be played back.

### SUMMARY OF THE INVENTION

The present invention is devised in order to solve the above conventional problems, and its object is to provide an audio processing apparatus that can output a fourth room left audio signal (or a third room left audio signal) without releasing the connection of the surround left speaker.

An audio processing apparatus according to a preferred embodiment of the present invention comprises: a first amplifier that amplifies a surround left audio signal (or a surround right audio signal) or a fourth room left audio signal (or a fourth room right audio signal); a second amplifier; a third amplifier; a first speaker terminal that outputs the surround left audio signal; a second speaker terminal that outputs a first extended left audio signal (or a first extended right audio signal) or the fourth room left audio signal; a third speaker terminal that outputs a second extended left audio signal (or a second extended right audio signal) or a second room left audio signal (or a second room right audio signal); a fourth speaker terminal that outputs a third extended left audio signal (or a third extended right audio signal) or a third room left audio signal (or a third room right audio signal); a first switch that switches whether the surround left audio signal from the first amplifier is supplied to the first speaker terminal; a second switch that switches whether the fourth room left audio signal from the first amplifier is supplied to the second speaker terminal; a third switch that switches whether the amplified first extended left audio signal is supplied to the second speaker terminal; a fourth switch that switches whether the amplified second extended left audio signal or the amplified second room left audio signal is supplied to the third speaker terminal; a fifth switch that switches whether the amplified third extended left audio signal or the amplified third room left audio signal is supplied to the fourth speaker terminal; and a switching controller that controls the first switch, the second switch, the third switch, the fourth switch, and the fifth switch.

In the case that the fourth room left audio signal is output, the first switch is controlled in the off state, the second switch is controlled in the on state, and the third switch is controlled in the off state. Accordingly, the fourth room left audio signal is amplified by the first amplifier and supplied to the second speaker terminal through the second switch. The first speaker terminal is the output terminal dedicated to the surround left audio signal, so that the fourth room left audio signal can be output without releasing the connection of the surround left speaker.

An audio processing apparatus according to a preferred embodiment of the present invention comprises: a first amplifier that amplifies a surround left audio signal (or a surround right audio signal) or a third room left audio signal (or a third room right audio signal); a second amplifier that amplifies a first extended left audio signal (or a first extended right audio signal), a second extended left audio signal (or a second extended right audio signal), a third extended left audio signal (or a third extended right audio signal), or a second room left audio signal (or a second room right audio signal); a first speaker terminal that outputs the surround left audio signal; a second speaker terminal that outputs the first extended left audio signal; a third speaker terminal that outputs the second extended left audio signal or the second room left audio signal; a fourth speaker terminal that outputs the third extended left audio signal or the third room left audio signal; a first switch that switches whether the surround left audio signal from the first amplifier is supplied to the first speaker terminal; a second switch that switches whether the third room left audio signal from the first amplifier is supplied to the fourth speaker terminal; a third switch that switches whether the first extended left audio signal from the second amplifier is supplied to the second speaker terminal; a fourth switch that switches whether the second extended left audio signal or the second room left audio signal from the second amplifier is supplied to the third speaker terminal; a fifth switch that switches whether the third extended left audio signal from the second amplifier is supplied to the fourth speaker terminal; and a switching controller that controls the first switch, the second switch, the third switch, the fourth switch, and the fifth switch.

In the case that the third room left audio signal is output, the first switch is controlled in the off state, the second switch is controlled in the on state, and the fifth switch is controlled in the off state. Accordingly, the third room left audio signal is amplified by the first amplifier and supplied to the fourth speaker terminal through the second switch. The first speaker terminal is the output terminal dedicated to the surround left audio signal, so that the third room left audio signal can be output without releasing the connection of the surround left speaker.

In a preferred embodiment, the first extended left audio signal is any one of a surround back left audio signal, a left outside audio signal, a left upside audio signal, and a left-central-side audio signal (or the first extended right audio signal is any one of a surround back right audio signal, a right outside audio signal, a right upside audio signal, and a right-central-side audio signal), the second extended left audio signal is any one of the surround back left audio signal, the left outside audio signal, the left upside audio signal, and the left-central-side audio signal and is different from the first extended left audio signal (or the second extended right audio signal is any one of the surround back right audio signal, the right outside audio signal, the right upside audio signal, and the right-central-side audio signal and different from the first extended right audio signal), and the third extended left audio signal is any one of the surround back left audio signal, the left outside audio signal, the left upside audio signal, and the left-central-side audio signal and different from the first extended left audio signal and the second extended left audio signal (or the third extended right audio signal is any one of the surround back right audio signal, the right outside audio signal, the right upside audio signal, and the right-central-side audio signal and different from the first extended right audio signal and the second extended right audio signal).

The present invention includes one of the above configurations, so that the audio processing apparatus that can output the fourth room left audio signal (or the third room left audio signal) without releasing the connection of the surround left speaker can be provided.

### BRIEF DESCRIPTION OF THE DRAWINGS

FIG. 1 is a view illustrating dispositions of an AV amplifier and speakers;

FIG. 2 is a view illustrating dispositions of the AV amplifier and the speakers;

FIG. 3 is a view illustrating an audio playback system;

FIG. 4 is a view illustrating channels of audio signals;

FIG. 5 is a view illustrating an audio processing unit;

FIG. 6 is a view illustrating the audio processing unit;

FIG. 7 is a view illustrating channels of audio signals;

FIG. 8 is a view illustrating the audio processing unit;

FIG. 9 is a view illustrating the audio processing unit;

FIG. 10 is a view illustrating dispositions of the AV amplifier and the speakers;

FIG. 11 is a view illustrating the audio processing unit;

FIG. 12 is a view illustrating the audio processing unit;

FIG. 13 is a view illustrating the audio processing unit;

FIG. 14 is a view illustrating the audio processing unit;

FIG. 15 is a view illustrating an audio processing unit of the related art; and

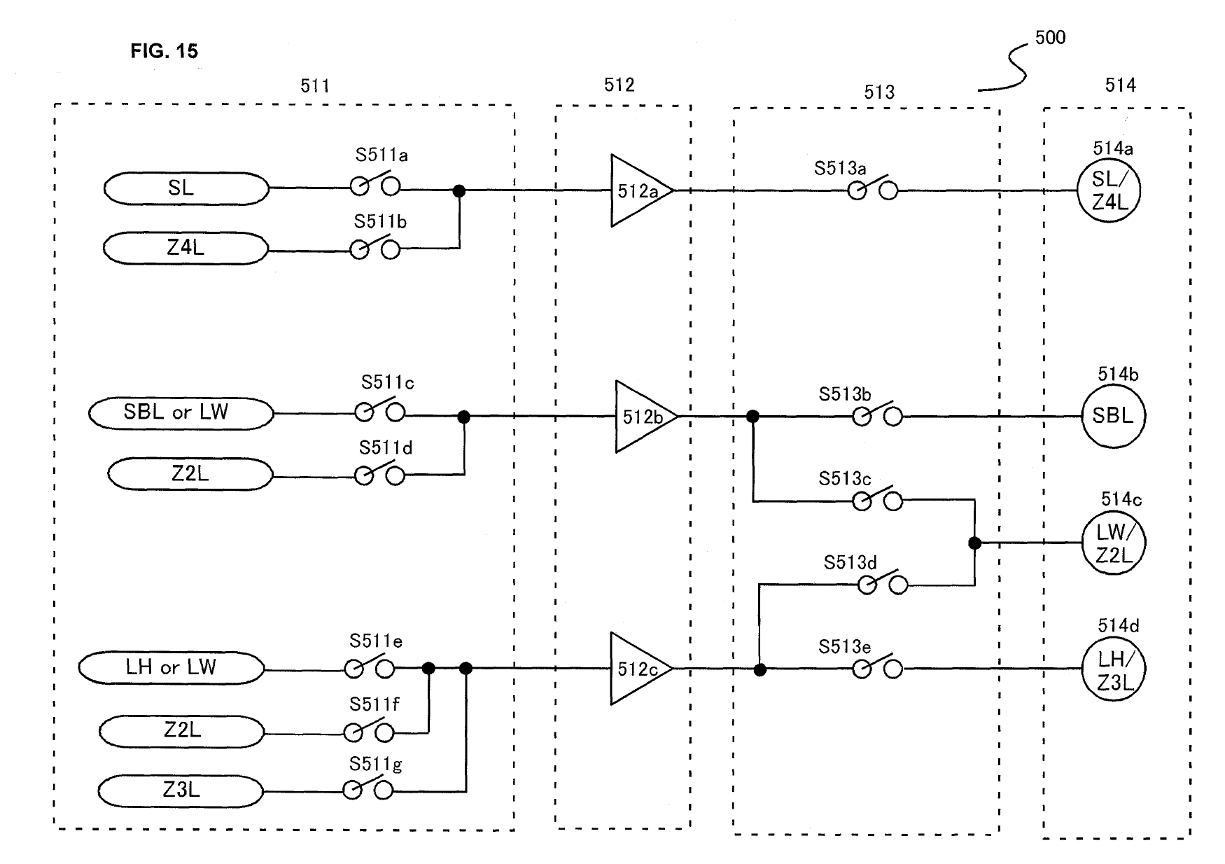

FIG. 16 is a view illustrating the audio processing unit of the related art.

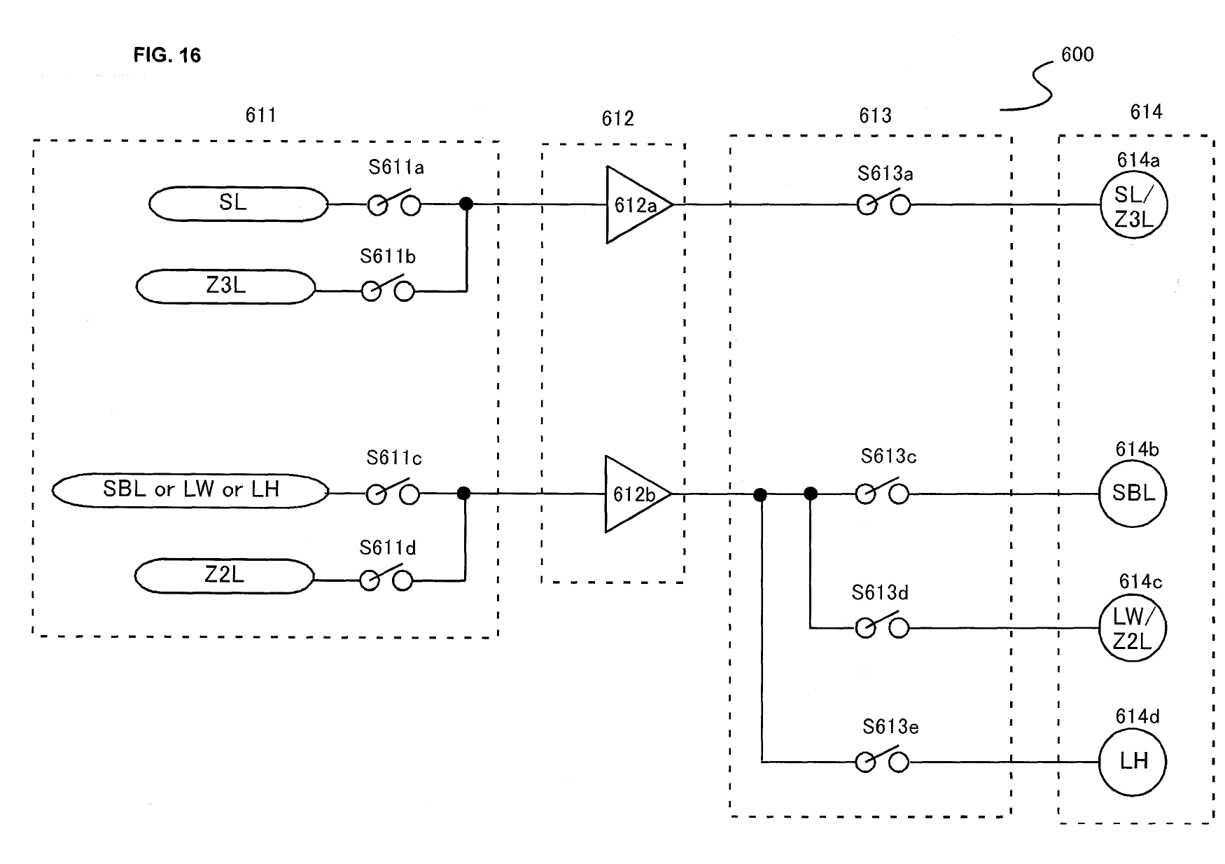

### DETAILED DESCRIPTION OF THE PREFERRED EMBODIMENTS

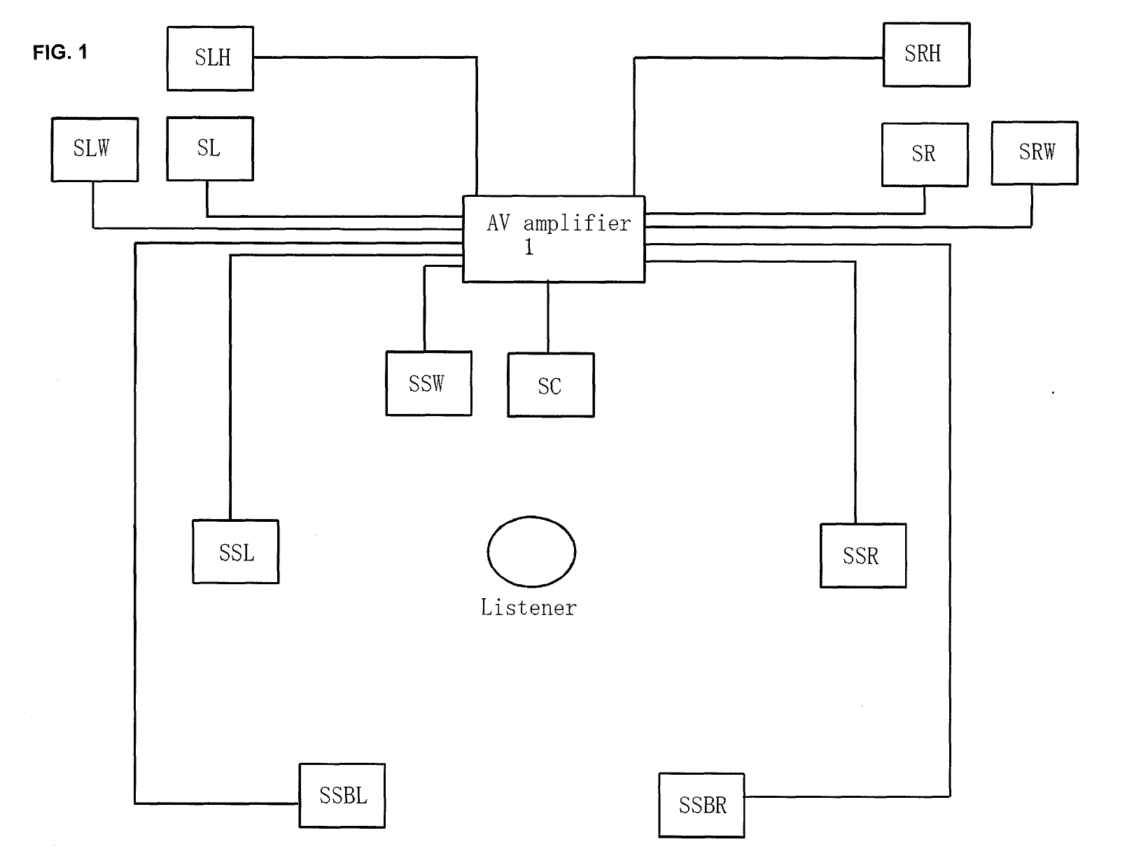

Hereinafter, an audio playback system including a disk playback apparatus (hereinafter referred to as a BD player), an audio processing apparatus (hereinafter referred to as an AV amplifier), and a display device according to preferred embodiments of the present invention will specifically be described with reference to the drawings. However, the present invention is not limited to the embodiments. FIG. 1 is a view illustrating an example of dispositions of an AV amplifier 1 and speakers according to a first embodiment. A left speaker SL, a right speaker SR, a central speaker SC, a low-frequency speaker SSW, a surround left speaker SSL, a surround right speaker SSR, a surround back left speaker SSBL, a surround back right speaker SSBR, an left upside speaker SLH, an right upside speaker SRH, a left outside speaker SLW, and a right outside speaker SRW are connected to the AV amplifier 1.

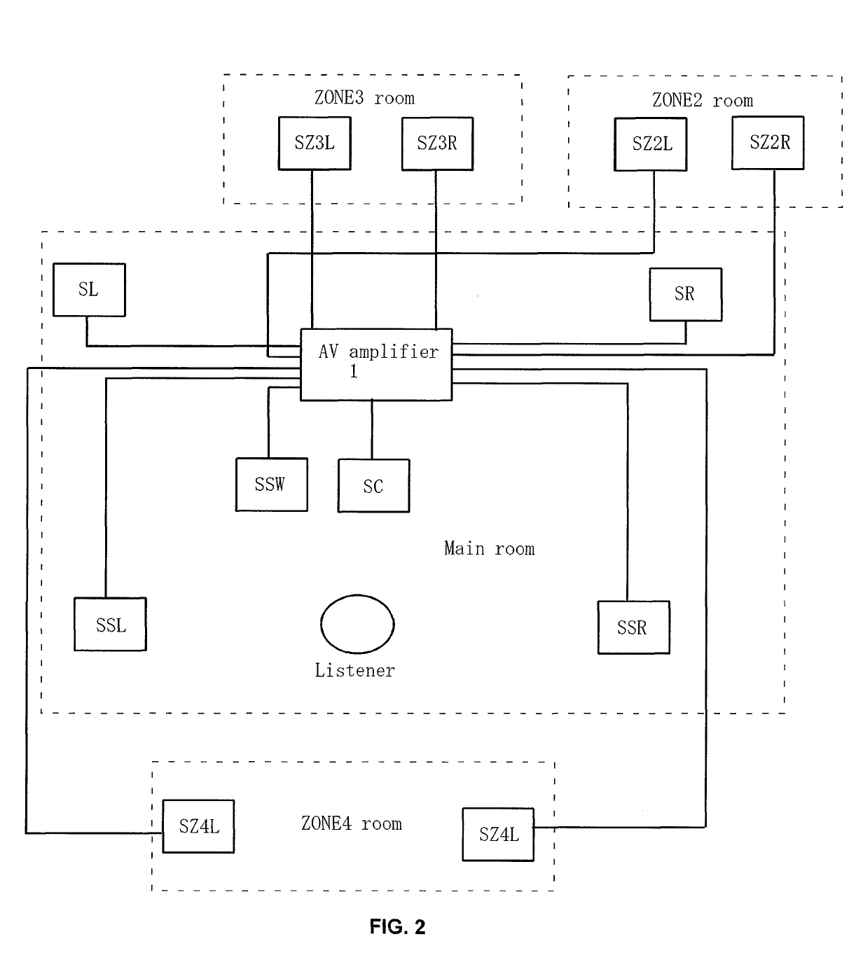

FIG. 2 illustrates a state in which a ZONE2 left speaker SZ2L, ZONE2 right speaker SZ2R, a ZONE3 left speaker SZ3L, a ZONE3 right speaker SZ3R, a ZONE4 left speaker SZ4L, and a ZONE4 right speaker SZ4R are connected instead of the surround back left speaker SSBL, the surround back right speaker SSBR, the left upside speaker SLH, the right upside speaker SRH, the left outside speaker SLW, and the right outside speaker SRW in FIG. 1.

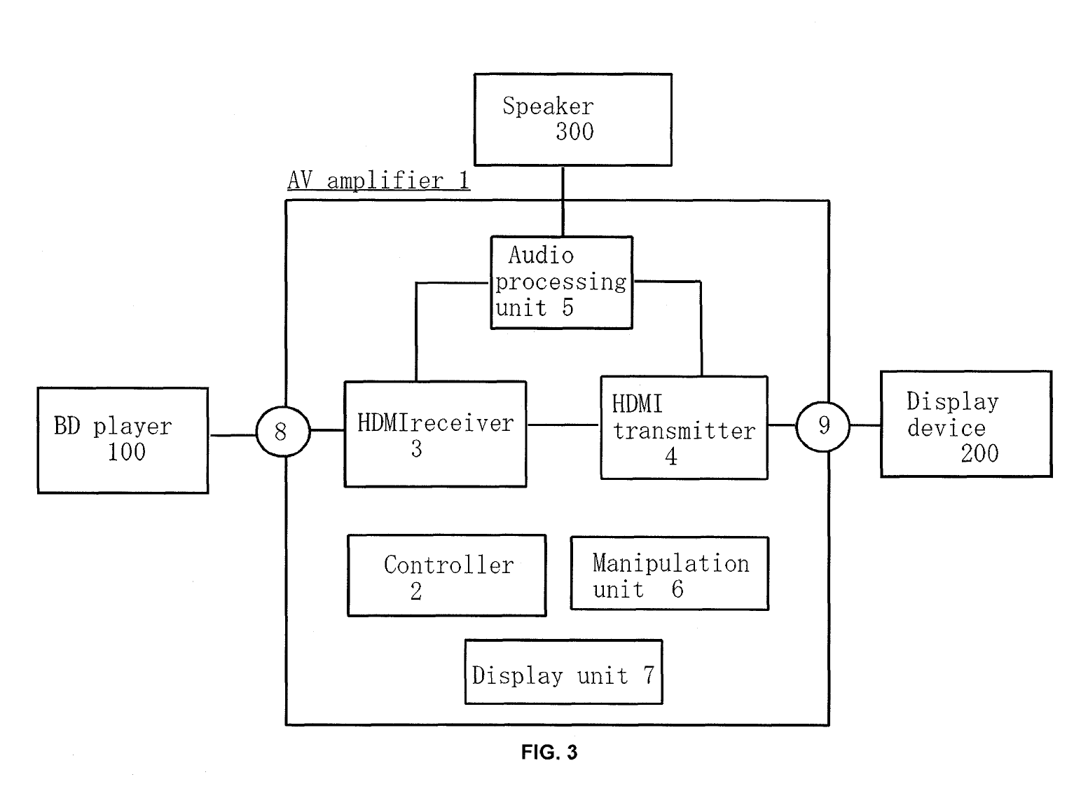

FIG. 3 is a block diagram illustrating a configuration of an audio playback system. For example, a BD player 100, the AV amplifier 1, and a display device 200 are compliant with an HDMI standard, and are connected to one another through an HDMI cable. The BD player 100 transmits HDMI data including multichannel audio data and video data to the AV amplifier 1. The AV amplifier 1 amplifies the multichannel audio data, which is received from the BD player 100 and included in the HDMI data, and outputs the multichannel audio data to the speakers. The AV amplifier 1 transmits the HDMI data including the video data to the display device 200. The display device 200 displays the video data, which is received from the AV amplifier 1 and included in the HDMI data.

The AV amplifier 1 includes a controller 2, an HDMI receiver 3, an HDMI transmitter 4, an audio processing unit 5, a manipulation unit 6, a display unit 7, and HDMI terminals 8 and 9. A speaker 300 (corresponding to the speakers in FIGS. 1 and 2) is connected to the AV amplifier 1.

The HDMI receiver 3 receives the HDMI data transmitted from the BD player 100, generates original video data from the received HDMI data, and supplies the original video data to the HDMI transmitter 4. The HDMI receiver 3 generates original multichannel audio data from the received HDMI data, and supplies the original multichannel audio data to the audio processing unit 5.

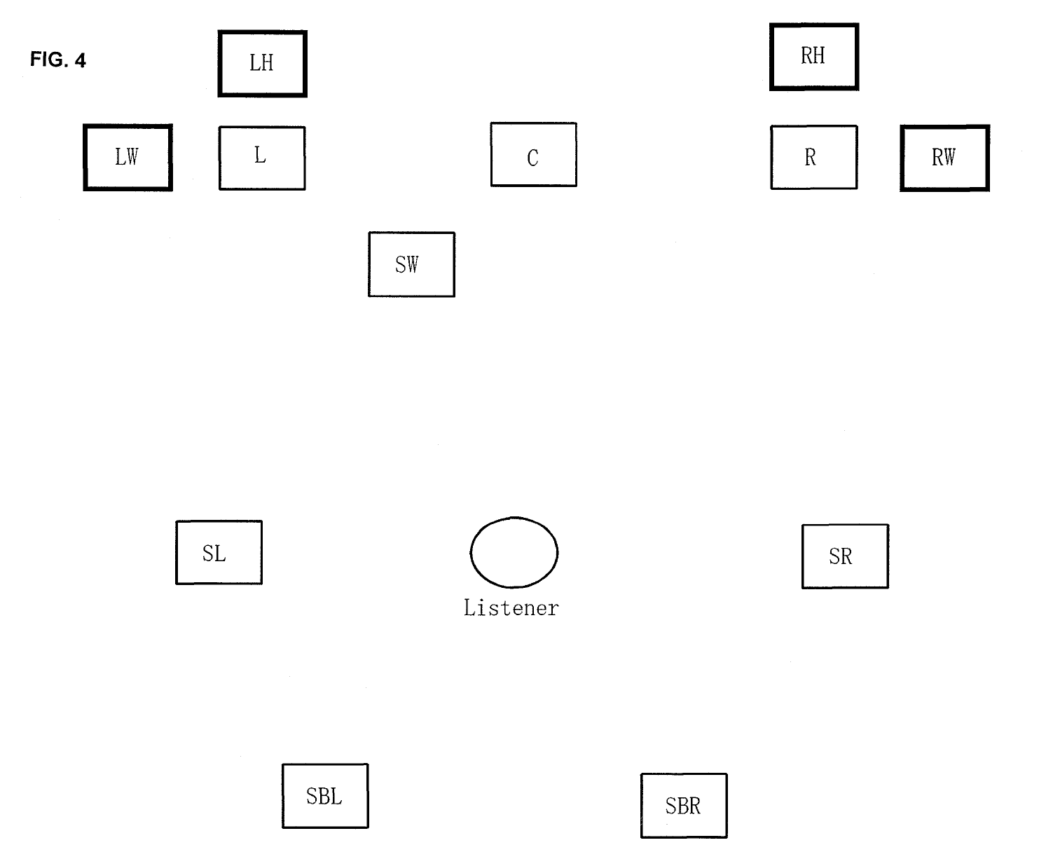

The audio processing unit 5 decodes the multichannel audio data supplied from the HDMI receiver 3, performs pieces of processing, such as acoustic processing, D/A conversion processing, a volume adjusting processing, and amplifying processing, and supplies an audio signal of each channel to the speaker 300. The multichannel audio data supplied to the audio processing unit 5 will be described. As illustrated in FIG. 4, for example, HD (High Definition)-related audio formats, such as Dolby True HD, Dolby Digital Plus, and DTS-HD include a left audio signal L (front left audio signal), a right audio signal R (front right audio signal), a central audio signal C, a low-frequency audio signal SW, a surround left audio signal SL, a surround right audio signal SR, a surround back left audio signal SBL, a surround back right audio signal SBR, a left outside audio signal LW, a right outside audio signal RW, an left upside audio signal LH, and an right upside audio signal RH.

The surround back left audio signal SBL is played back from a position on a back left side of a user. The surround back right audio signal SBR is played back from a position on a back right side of the user. The left outside audio signal LW is played back from a position (that is, on a front left outside of the user) of an outside (a left side) of the left audio signal L. The right outside audio signal RW is played back from a position (that is, on a front right outside of the user) of an outside (a right side) of the right audio signal R. The left upside audio signal LH is played back from a position (that is, on a front left upside of the user) of an upside of the left audio signal L. The right upside audio signal RH is played back from a position (that is, on a front right upside of the user) of the upside of the right audio signal R.

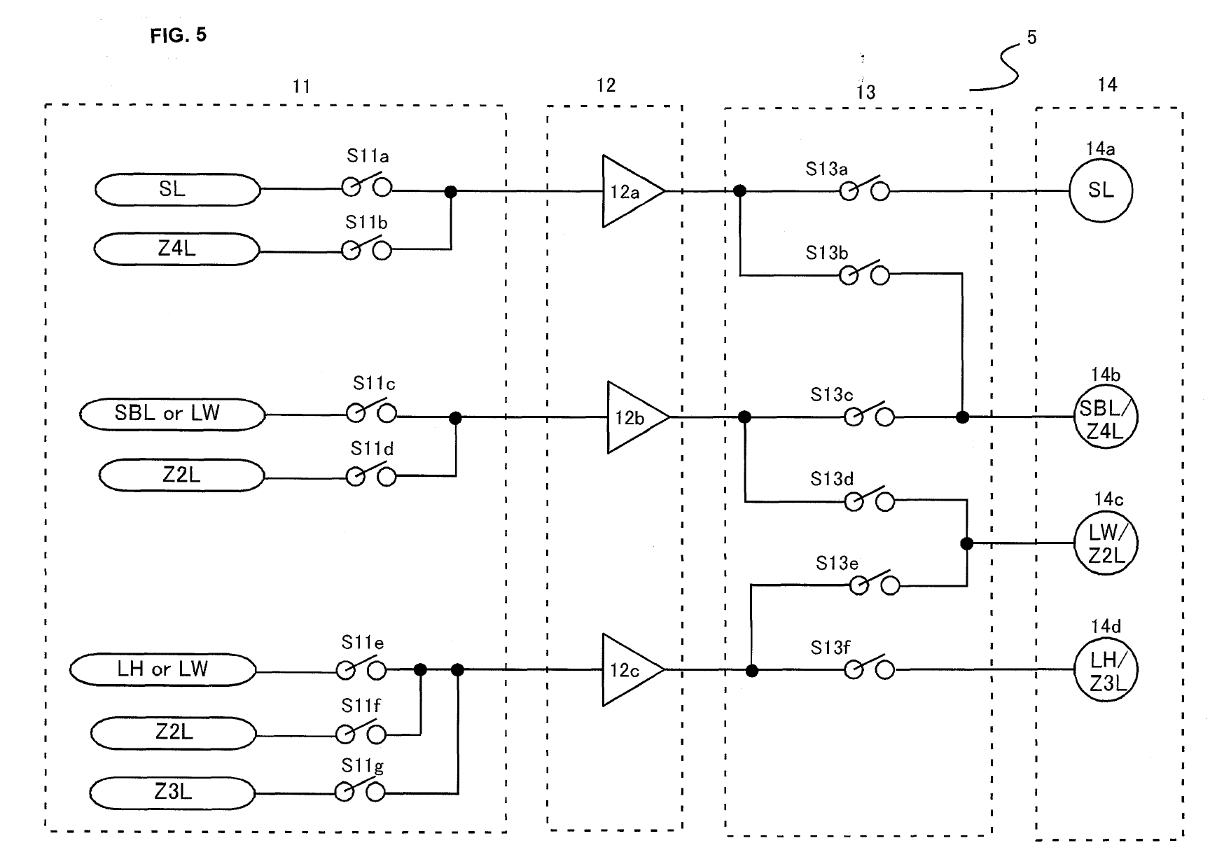

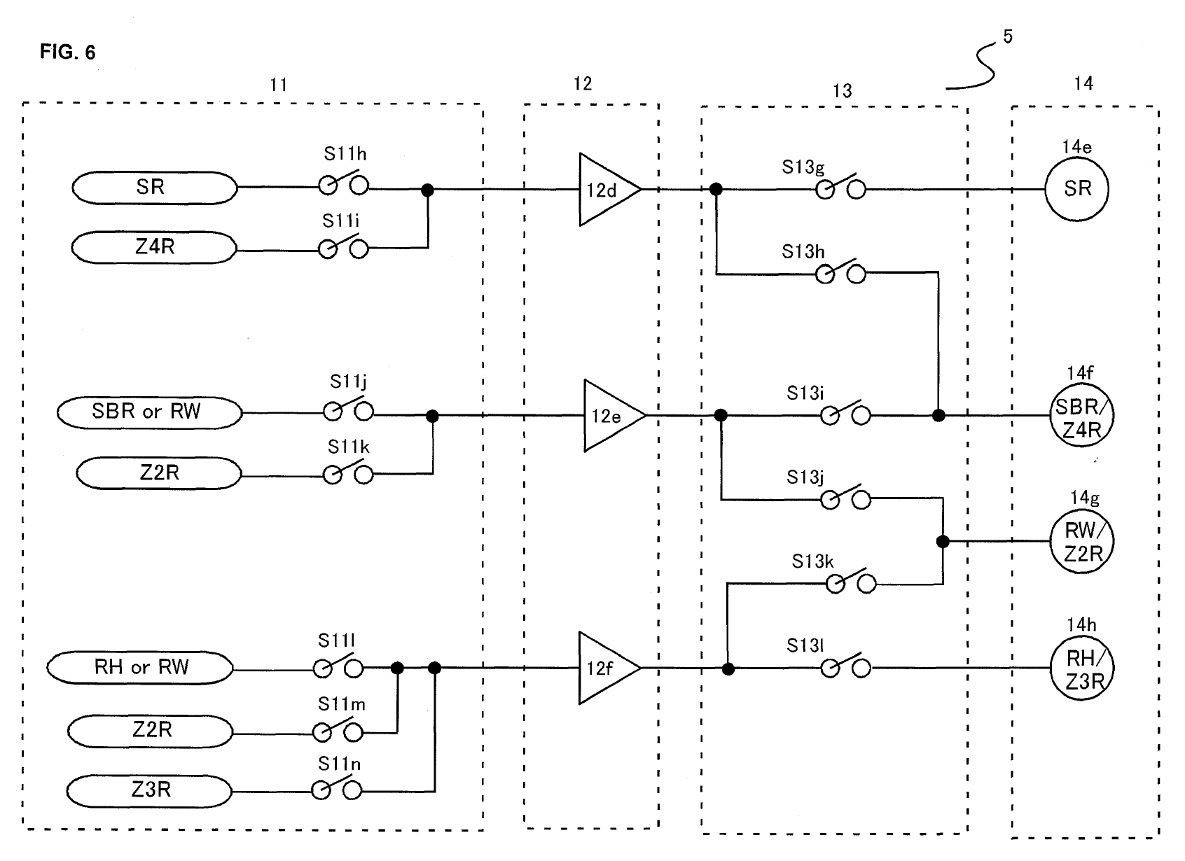

FIGS. 5 and 6 are block diagrams illustrating a main part of the audio processing unit 5. FIG. 5 illustrates a configuration related to a left channel, and FIG. 6 illustrates a configuration related to a right channel. The audio processing unit 5 includes a front-stage SP (speaker) relay 11, a power amplifier 12, a latter-stage SP (speaker) relay 13, and an SP (speaker) terminal 14. In FIGS. 5 and 6, because circuits related to 3.1 channels (the left audio signal L, the right audio signal R, the central audio signal C, and the low-frequency audio signal SW) in basic 5.1 channels are identical to those of the related art, the circuits are omitted. A DSP and the like provided at a front-stage of the front-stage SP relay 11 are also omitted.

The DSP decodes the multichannel audio data supplied from the HDMI receiver 3, and generates the audio data of each channel. The generated audio data is supplied to the front-stage SP relay 11.

The front-stage SP relay 11 includes switches S11a to S11g. On-off control is performed to each switch in response to an instruction from the controller 2.

The switch S11a switches whether the surround left audio signal SL input from the DSP is supplied to an amplifier 12a. The switch S11b switches whether the ZONE4 left audio signal Z4L supplied from the DSP is supplied to the amplifier 12a. The switch S11c switches whether the surround back left audio signal SBL or the left outside audio signal LW, which is input from the DSP, is supplied to an amplifier 12b. The switch S11d switches whether the ZONE2 left audio signal Z2L supplied from the DSP is supplied to the amplifier 12b. The switch S11d switches whether the left upside audio signal LH or the left outside audio signal LW, which is input from the DSP, is supplied to an amplifier 12c. The switch S11f switches whether the ZONE2 left audio signal Z2L supplied from the DSP is supplied to the amplifier 12c. The switch S11g switches whether the ZONE3 left audio signal Z3L supplied from the DSP is supplied to the amplifier 12c.

The switch S11h switches whether the surround right audio signal SR input from the DSP is supplied to an amplifier 12d. The switch S11i switches whether the ZONE4 right audio signal Z4R supplied from the DSP is supplied to the amplifier 12d. The switch S11j switches whether the surround back right audio signal SBR or the right outside audio signal RW, which is input from the DSP, is supplied to an amplifier 12e. The switch S11k switches whether the ZONE2 right audio signal Z2R supplied from the DSP is supplied to the amplifier 12e. The switch S111 switches whether the right upside audio signal RH or the right outside audio signal RW, which is input from the DSP, is supplied to an amplifier 12f. The switch S11m switches whether the ZONE2 right audio signal Z2R supplied from the DSP is supplied to the amplifier 12f. The switch S11n switches whether the ZONE3 right audio signal Z3R supplied from the DSP is supplied to the amplifier 12f.

The power amplifier 12 includes amplifiers 12a to 12f. The amplifier 12a amplifies the surround left audio signal SL supplied from the switch S11a, and supplies the surround left audio signal SL to the latter-stage SP relay 13 (a switch 513a). Alternatively, the amplifier 12a amplifies the ZONE4 left audio signal Z4L supplied from the switch S11b, and supplies the ZONE4 left audio signal Z4L to the latter-stage SP relay 13 (a switch S13b). The amplifier 12b amplifies the surround back left audio signal SBL supplied from the switch S11c, and supplies the surround back left audio signal SBL to the latter-stage SP relay 13 (a switch S13c). Alternatively, the amplifier 12b amplifies the left outside audio signal LW supplied from the switch S11c, and supplies the left outside audio signal LW to the latter-stage SP relay 13 (a switch S13d). Alternatively, the amplifier 12b amplifies the ZONE2 left audio signal Z2L supplied from the switch S11d, and supplies the ZONE2 left audio signal Z2L to the latter-stage SP relay 13 (a switch S13d). The amplifier 12c amplifies the left upside audio signal LH supplied from the switch S11e, and supplies the left upside audio signal LH to the latter-stage SP relay 13 (a switch 513f). Alternatively, the amplifier 12c amplifies the left outside audio signal LW supplied from the switch S11e, and supplies the left outside audio signal LW to the latter-stage SP relay 13 (a switch S13e). Alternatively, the amplifier 12c amplifies the ZONE2 left audio signal Z2L supplied from the switch S11f, and supplies the ZONE2 left audio signal Z2L to the latter-stage SP relay 13 (a switch 513e). Alternatively, the amplifier 12c amplifies the ZONE3 left audio signal Z3L supplied from the switch 511g, and supplies the ZONE3 left audio signal Z3L to the latter-stage SP relay 13 (a switch S13f).

The amplifier 12d amplifies the surround right audio signal SR supplied from the switch S11h, and supplies the surround right audio signal SR to the latter-stage SP relay 13 (a switch 513g). Alternatively, the amplifier 12d amplifies the ZONE4 right audio signal Z4R supplied from the switch S11i, and supplies the ZONE4 right audio signal Z4R to the latter-stage SP relay 13 (a switch S13h). The amplifier 12e amplifies the surround back right audio signal SBR supplied from the switch S11j, and supplies the surround back right audio signal SBR to the latter-stage SP relay 13 (a switch S13i). Alternatively, the amplifier 12e amplifies the right outside audio signal RW supplied from the switch S11j, and supplies the right outside audio signal RW to the latter-stage SP relay 13 (a switch S13j). Alternatively, the amplifier 12e amplifies the ZONE2 right audio signal Z2R supplied from the switch S11k, and supplies the ZONE2 right audio signal Z2R to the latter-stage SP relay 13 (a switch S13j). The amplifier 12f amplifies the right upside audio signal RH supplied from the switch S111, and supplies the right upside audio signal RH to the latter-stage SP relay 13 (a switch S131). Alternatively, the amplifier 12f amplifies the right outside audio signal RW supplied from the switch S111, and supplies the right outside audio signal RW to the latter-stage SP relay 13 (a switch S13k). Alternatively, the amplifier 12f amplifies the ZONE2 right audio signal Z2R supplied from the switch S11m, and supplies the ZONE2 right audio signal Z2R to the latter-stage SP relay 13 (a switch S13k). Alternatively, the amplifier 12f amplifies the ZONE3 right audio signal Z3R supplied from the switch S11n, and supplies the ZONE3 right audio signal Z3R to the latter-stage SP relay 13 (a switch S131).

The latter-stage SP relay 13 includes relay switches (hereinafter referred to as switches) 513a to S131. The on-off control is performed to each switch in response to the instruction from the controller 2.

The switch 513a switches whether the surround left audio signal SL supplied from the amplifier 12a is supplied to a surround left SP terminal 14a. The switch S13b switches whether the ZONE4 left audio signal Z4L supplied from the amplifier 12a is supplied to a surround back left/ZONE4 left SP terminal 14b. The switch S13c switches whether the surround back left audio signal SBL supplied from the amplifier 12b is supplied to the surround back left/ZONE4 left SP terminal 14b. The switch S13d switches whether the left outside audio signal LW or the ZONE2 left audio signal Z2L, which is supplied from the amplifier 12b, is supplied to a left outside/ZONE2 left SP terminal 14c. The switch 513e switches whether the left outside audio signal LW or the ZONE2 left audio signal Z2L, which is supplied from the amplifier 12c, is supplied to the left outside/ZONE2 left SP terminal 14c. The switch S13f switches whether the left upside audio signal LH or the ZONE3 left audio signal Z3L, which is supplied from the amplifier 12c, is supplied to a left upside/ZONE3 left SP terminal 14d.

The switch S13g switches whether the surround right audio signal SR supplied from the amplifier 12d is supplied to a surround right SP terminal 14e. The switch S13h switches whether the ZONE4 right audio signal Z4R supplied from the amplifier 12d is supplied to a surround back right/ZONE4 right SP terminal 14f. The switch S13i switches whether the surround back right audio signal SBR supplied from the amplifier 12e is supplied to the surround back right/ZONE4 right SP terminal 14f. The switch S13j switches whether the right outside audio signal RW or the ZONE2 right audio signal Z2R, which is supplied from the amplifier 12e, is supplied to a right outside/ZONE2 right SP terminal 14g. The switch S13k switches whether the right outside audio signal RW or the ZONE2 right audio signal Z2R, which is supplied from the amplifier 12f, is supplied to the right outside/ZONE2 right SP terminal 14g. The switch S131 switches whether the right upside audio signal RH or the ZONE3 right audio signal Z3R, which is supplied from the amplifier 12f, is supplied to a right upside/ZONE3 right SP terminal 14h.

The SP terminal 14 includes the SP terminals 14a to 14h. The surround left speaker SSL is connected to the surround left SP terminal 14a. The surround back left speaker SSBL or the ZONE4 left speaker SZ4L is connected to the surround back left/ZONE4 left SP terminal 14b. The left outside speaker SLW or the ZONE2 left speaker SZ2L is connected to the left outside/ZONE2 left SP terminal 14c. The left upside speaker SLH or the ZONE3 left speaker SZ3L is connected to the left upside/ZONE3 left SP terminal 14d.

The surround right speaker SSR is connected to the surround right SP terminal 14e. The surround back right speaker SSBR or the ZONE4 right speaker SZ4R is connected to the surround back right/ZONE4 right SP terminal 14f. The right outside speaker SRW or the ZONE2 right speaker SZ2R is connected to the right outside/ZONE2 right SP terminal 14g. The right upside speaker SRH or the ZONE3 right speaker SZ3R is connected to the right upside/ZONE3 right SP terminal 14h.

Referring to FIG. 3, the HDMI transmitter 4 converts the video data supplied from the HDMI receiver 3 into the HDMI data, and transmits the HDMI data to the display device 200.

The controller 2 controls each unit based on an operating program of the AV amplifier, which is stored in a built-in or connected memory (not illustrated). For example, the controller 2 is a microcomputer or a CPU and the like. The controller 2 determines the channel included in the multichannel audio data (that is, the channel to be played back) or a ZONE output setting by a user manipulation, controls the audio signal supplied from the DSP to the switch, and performs the switching control of each switch. The multichannel audio data is not limited to the audio data received from the BD player 100, but the multichannel audio data maybe the audio data that is generated and output by the DSP.

The HDMI receiver 3 generates the original multichannel audio data from the HDMI data, and supplies the original multichannel audio data to the audio processing unit 5. The audio processing unit 5 decodes the multichannel audio data, reads channel information included in an information domain of the multichannel audio data, and supplies the channel information to the controller 2.

An operation of the first embodiment will be described below.

(In the Case that Surround Left Audio Signal SL and Surround Right Audio Signal SR are Played Back)

When determining that the multichannel audio data includes the surround left audio signal SL, the controller 2 controls the switches S11a and S13a in the on state, and controls the switches S11b and S13b in the off state. Accordingly, the surround left audio signal SL is supplied from the DSP to the amplifier 12a through the switch S11a, amplified by the amplifier 12a, and supplied to the surround left SP terminal 14a through the switch S13a.

When determining that the multichannel audio data includes the surround right audio signal SR, the controller 2 controls the switches S11h and S13g in the on state, and controls the switches S11i and S13h in the off state. Accordingly, the surround right audio signal SR is supplied from the DSP to the amplifier 12d through the switch S11h, amplified by the amplifier 12d, and supplied to the surround right SP terminal 14e through the switch S13g.

(In the Case that Surround Back Left Audio Signal SBL and Surround Back Right Audio Signal SBR are Played Back)

When determining that the multichannel audio data includes the surround back left audio signal SBL, the controller 2 controls the switches S11c and S13c in the on state, and controls the switches S11d, S13b, and S13d in the off state. Accordingly, the surround back left audio signal SBL is supplied from the DSP to the amplifier 12b through the switch S11c, amplified by the amplifier 12b, and supplied to the surround back left/ZONE4 left SP terminal 14b through the switch S13c.

When determining that the multichannel audio data includes the surround back right audio signal SBR, the controller 2 controls the switches S11j and S13i in the on state, and controls the switches S11k, 513h, and S13j in the off state. Accordingly, the surround back right audio signal SBR is supplied from the DSP to the amplifier 12e through the switch S11j, amplified by the amplifier 12e, and supplied to the surround back right/ZONE4 right SP terminal 14f through the switch S13i.

(In the Case that Left Upside Audio Signal LH and Right Upside Audio Signal RH are Played Back)

When determining that the multichannel audio data includes the left upside audio signal LH, the controller 2 controls the switches S11e and S13f in the on state, and controls the switches S11f, S11g, and S13e in the off state. Accordingly, the left upside audio signal LH is supplied from the DSP to the amplifier 12c through the switch S11e, amplified by the amplifier 12c, and supplied to the left upside/ZONE3 left SP terminal 14d through the switch S13f.

When determining that the multichannel audio data includes the right upside audio signal RH, the controller 2 controls the switches S111 and S131 in the on state, and controls the switches S11m, S11n, and S13k in the off state. Accordingly, the right upside audio signal RH is supplied from the DSP to the amplifier 12f through the switch S111, amplified by the amplifier 12f, and supplied to the right upside/ZONE3 right SP terminal 14h through the switch S131.

### (In the Case Left Outside Audio Signal LW and Right Outside Audio Signal RW are Played Back (1))

When determining that the multichannel audio data includes the left outside audio signal LW, the controller 2 controls the switches S11c and S13d in the on state, and controls the switches S11d, S13c, and 13e in the off state. Accordingly, the left outside audio signal LW is supplied from the DSP to the amplifier 12b through the switch S11c, amplified by the amplifier 12b, and supplied to the left outside/ZONE2 left SP terminal 14c through the switch S13d.

When determining that the multichannel audio data includes the right outside audio signal RW, the controller 2 controls the switches S11j and S13j in the on state, and controls the switches S11k, S13i, and S13k in the off state. Accordingly, the right outside audio signal RW is supplied from the DSP to the amplifier 12e through the switch S11j, amplified by the amplifier 12e, and supplied to the right outside/ZONE2 right SP terminal 14g through the switch S13j.

In this case, one of the left upside audio signal LH and the ZONE3 left audio signal Z3L can be played back while the left outside audio signal LW is played back. Additionally the ZONE4 left audio signal Z4L can be played back while the left outside audio signal LW is played back. Similarly one of the right upside audio signal RH and the ZONE3 right audio signal Z3R can be played back while the right outside audio signal RW is played back. Additionally the ZONE4 right audio signal Z4R can be played back while the right outside audio signal RW is played back.

(In the Case that Left Outside Audio Signal LW and Right Outside Audio Signal RW are Played Back (2))

When determining that the multichannel audio data includes the left outside audio signal LW, the controller 2 controls the switches S11e and S13e in the on state, and controls the switches S11f, S11g, S13d, and 13f in the off state. Accordingly, the left outside audio signal LW is supplied from the DSP to the amplifier 12c through the switch S11e, amplified by the amplifier 12c, and supplied to the left outside/ZONE2 left SP terminal 14c through the switch S13e.

When determining that the multichannel audio data includes the right outside audio signal RW, the controller 2 controls the switches S111 and S13k in the on state, and controls the switches S11m, S11n, S13j, and 131 in the off state. Accordingly, the right outside audio signal RW is supplied from the DSP to the amplifier 12f through the switch S111, amplified by the amplifier 12f, and supplied to the right outside/ZONE2 right SP terminal 14g through the switch S13k.

In this case, one of the surround back left audio signal SBL and the ZONE4 left audio signal Z4L can be played back while the left outside audio signal LW is played back. Similarly one of the surround back right audio signal SBR and the ZONE4 right audio signal Z4R can be played back while the right outside audio signal RW is played back.

(In the Case that ZONE4 Left Audio Signal Z4L and ZONE4 Right Audio Signal Z4R are Played Back)

When determining that the playback of the ZONE4 left audio signal Z4L is set by the user manipulation, the controller 2 controls the switches S11b and S13b in the on state, and controls the switches S11a, 513a, and S13c in the off state. Accordingly, the ZONE4 left audio signal Z4L is supplied from the DSP to the amplifier 12a through the switch S11b, amplified by the amplifier 12a, and supplied to the surround back left/ZONE4 left SP terminal 14b through the switch S13b.

When determining that the playback of the ZONE4 right audio signal Z4R is set by the user manipulation, the controller 2 controls the switches S11i and 513h in the on state, and controls the switches S11h, 513g, and S13i in the off state. Accordingly, the ZONE4 right audio signal Z4R is supplied from the DSP to the amplifier 12d through the switch S11i, amplified by the amplifier 12d, and supplied to the surround back right/ZONE4 right SP terminal 14f through the switch S13h.

As described above, although the ZONE4 left audio signal Z4L and the surround left audio signal SL cannot simultaneously be played back, the ZONE4 left audio signal Z4L is output from not the surround left SP terminal 14a but the surround back left/ZONE4 left SP terminal 14b. That is, the surround left SP terminal 14a is the dedicated speaker terminal for playing back the surround left audio signal SL. Accordingly, in order to playback the ZONE4 left audio signal Z4L, it is not necessary to release the connection of the surround left speaker SSL having the high use frequency. Similarly, although the ZONE4 right audio signal Z4R and the surround right audio signal SR cannot simultaneously be played back, the ZONE4 right audio signal Z4R is output from not the surround right SP terminal 14e but the surround back right/ZONE4 right SP terminal 14f. That is, the surround right SP terminal 14e is the dedicated speaker terminal for playing back the surround right audio signal SR. Accordingly, in order to play back the ZONE4 right audio signal Z4R, it is not necessary to release the connection of the surround right speaker SSR having the high use frequency.

The ZONE2 left audio signal Z2L (or the left outside audio signal LW) and the ZONE3 left audio signal Z3L (or the left upside audio signal LH) can be played back while the ZONE4 left audio signal Z4L is played back. Similarly the ZONE2 right audio signal Z2R (or the right outside audio signal RW) and the ZONE3 right audio signal Z3R (or the right upside audio signal RH) can be played back while the ZONE4 right audio signal Z4R is played back.

(In the Case that ZONE3 Left Audio Signal Z3L and ZONE3 Right Audio Signal Z3R are Played Back)

When determining that the playback of the ZONE3 left audio signal Z3L is set by the user manipulation, the controller 2 controls the switches S11g and S13f in the on state, and controls the switches S11e, S11f, and S13e in the off state. Accordingly, the ZONE3 left audio signal Z3L is supplied from the DSP to the amplifier 12c through the switch S11g, amplified by the amplifier 12c, and supplied to the left upside/ZONE3 left SP terminal 14d through the switch 513f.

When determining that the playback of the ZONE3 right audio signal Z3R is set by the user manipulation, the controller 2 controls the switches S11n and S131 in the on state, and controls the switches S111, S11m, and S13k in the off state. Accordingly, the ZONE3 right audio signal Z3R is supplied from the DSP to the amplifier 12f through the switch S11n, amplified by the amplifier 12f, and supplied to the right upside/ZONE3 right SP terminal 14h through the switch S131.

The ZONE2 left audio signal Z2L (or the left outside audio signal LW or the surround back left audio signal SBL) can be played back while the ZONE3 left audio signal Z3L is played back. The ZONE4 left audio signal Z4L (or the surround left audio signal SL) can be played back while the ZONE3 left audio signal Z3L is played back. Similarly the ZONE2 right audio signal Z2R (or the right outside audio signal RW or the surround back right audio signal BR) can be played back while the ZONE3 right audio signal Z3R is played back. The ZONE4 right audio signal Z4R (or the surround right audio signal SR) can be played back while the ZONE3 right audio signal Z3R is played back.

(In the Case that the ZONE2 Left Audio Signal Z2L and the ZONE2 Right Audio Signal Z2R are Played Back (1))

When determining that the playback of the ZONE2 left audio signal Z2L is set by the user manipulation, the controller 2 controls the switches S11d and S13d in the on state, and controls the switches S11c, S13c, and S13e in the off state. Accordingly, the ZONE2 left audio signal Z2L is supplied from the DSP to the amplifier 12b through the switch S11d, amplified by the amplifier 12b, and supplied to the left outside/ZONE2 left SP terminal 14c through the switch S13d.

When determining that the playback of the ZONE2 right audio signal Z2R is set by the user manipulation, the controller 2 controls the switches S11k and S13j in the on state, and controls the switches S11j, S13i, and S13k in the off state. Accordingly, the ZONE2 right audio signal Z2R is supplied from the DSP to the amplifier 12e through the switch S11k, amplified by the amplifier 12e, and supplied to the right outside/ZONE2 right SP terminal 14g through the switch S13j.

In this case, one of the left upside audio signal LH and the ZONE3 left audio signal Z3L can be played back while the ZONE2 left audio signal Z2L is played back. Additionally one of the ZONE4 left audio signal Z4L and the surround left audio signal SL can be played back while the ZONE2 left audio signal Z2L is played back. Similarly one of the right upside audio signal RH and the ZONE3 right audio signal Z3R can be played back while the ZONE2 right audio signal Z2R is played back. Additionally one of the ZONE4 right audio signal Z4R and the surround right audio signal SR can be played back while the ZONE2 right audio signal Z2R is played back.

In the Case that ZONE2 Left Audio Signal Z2L and ZONE2 Right Audio Signal Z2R are Played Back (2))

When determining that the playback of the ZONE2 left audio signal Z2L is set by the user manipulation, the controller 2 controls the switches S11f and S13e in the on state, and controls the switches S11e, S11g, S13d, and S13f in the off state. Accordingly, the ZONE2 left audio signal Z2L is supplied from the DSP to the amplifier 12c through the switch S11f, amplified by the amplifier 12c, and supplied to the left outside/ZONE2 left SP terminal 14c through the switch S13e.

When determining that the playback of the ZONE2 right audio signal Z2R is set by the user manipulation, the controller 2 controls the switches S11m and S13k in the on state, and controls the switches S111, S11n, S13j, and S131 in the off state. Accordingly, the ZONE2 right audio signal Z2R is supplied from the DSP to the amplifier 12f through the switch S11m, amplified by the amplifier 12f, and supplied to the right outside/ZONE2 right SP terminal 14g through the switch S13k.

In this case, one of the surround left audio signal SL and the ZONE4 left audio signal Z4L can be played back while the ZONE2 left audio signal Z2L is played back. Similarly one of the surround right audio signal SR and the ZONE4 right audio signal Z4R can be played back while the ZONE2 right audio signal Z2R is played back.

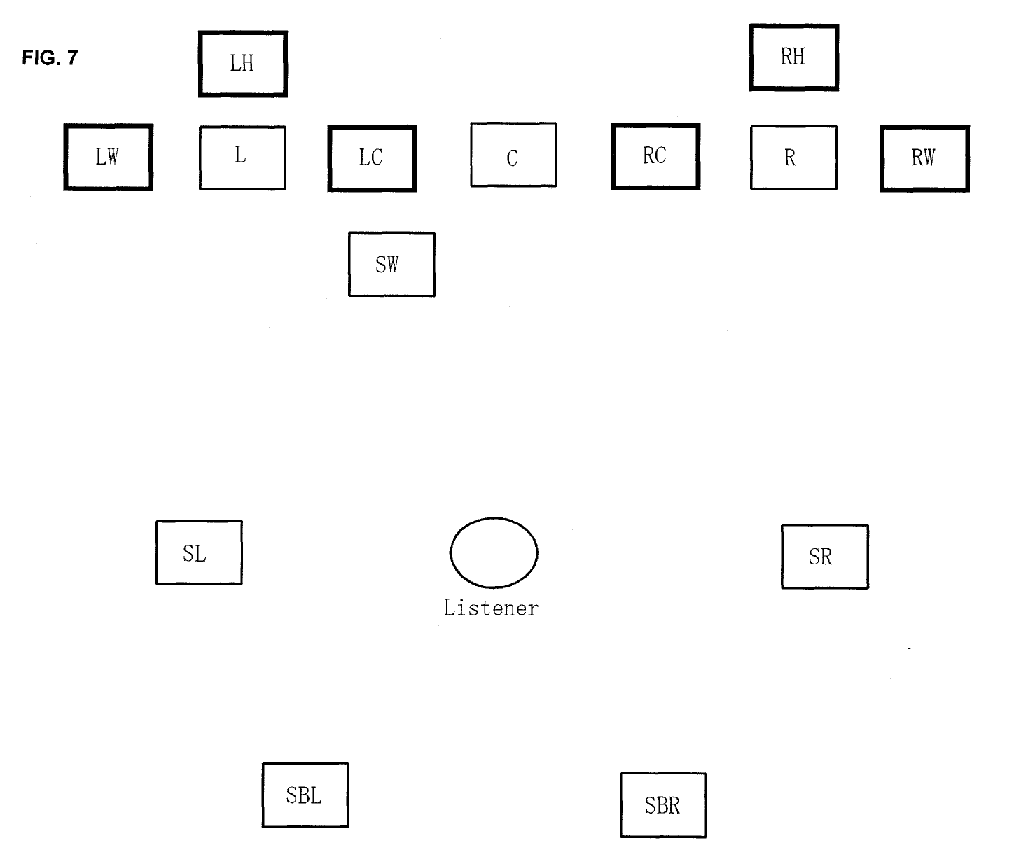

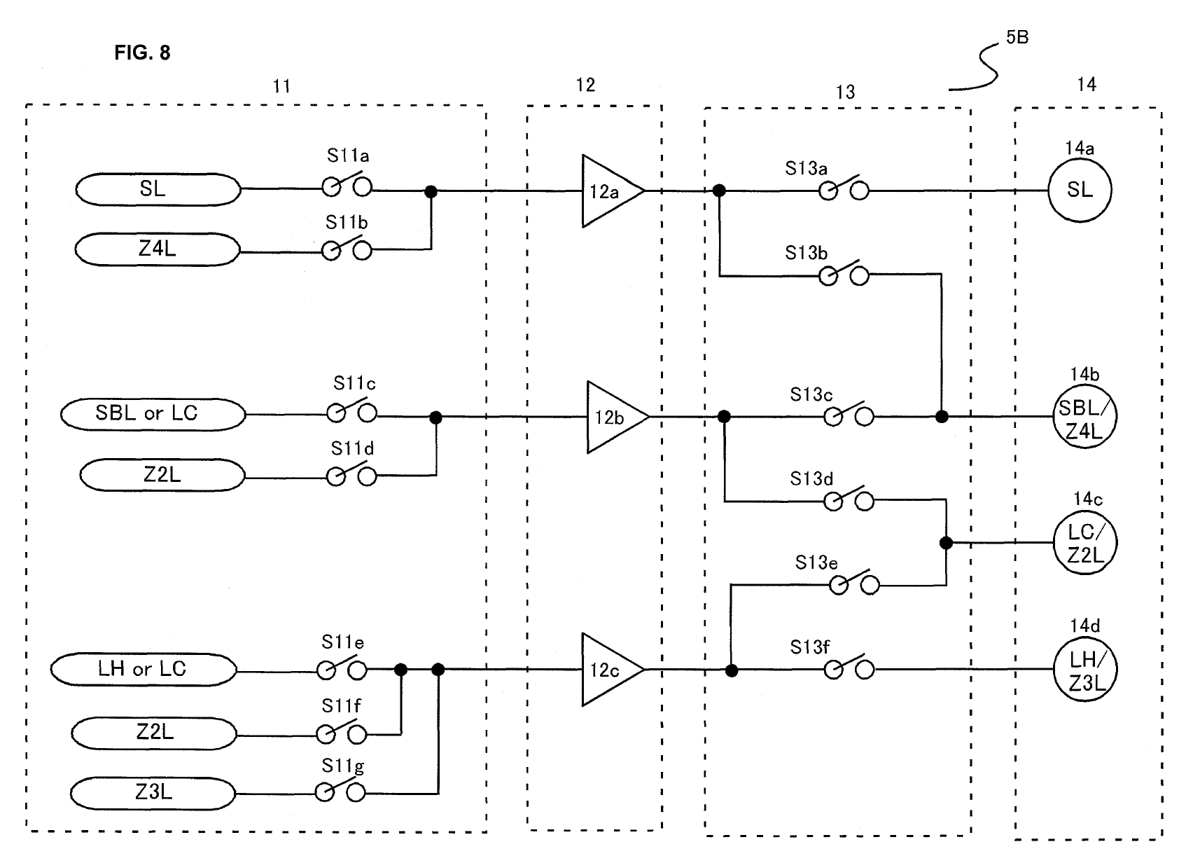

A second embodiment of the present invention will be described below. As illustrated in FIG. 7, in the second embodiment, a left-central-side audio signal LC exists instead of (or in addition to) the left outside audio signal LW, and a right-central-side audio signal RC exists instead of (or in addition to) the right outside audio signal RW. The left-central-side audio signal LC is played back from a position between the left audio signal L and the central audio signal C. The right-central-side audio signal RC is played back from a position between the right audio signal R and the central audio signal C. In this case, as illustrated in FIG. 8, a circuit configuration in which the left outside audio signal LW is replaced with the left-central-side audio signal LC while the right outside audio signal RW is replaced with the right-central-side audio signal RC may be used.

When the second embodiment is generally expressed in consideration of the circuit configuration in FIG. 8, the surround back left audio signal SBL is defined as a first extended left audio signal, the surround back right audio signal SBR is defined as a first extended right audio signal, the left outside audio signal LW is defined as a second extended left audio signal, the right outside audio signal RW is defined as a second extended right audio signal, the left upside audio signal LH is defined as a third extended left audio signal, and the right upside audio signal RH is defined as a third extended right audio signal.

The first extended left audio signal may be any one of the surround back left audio signal SBL, the left outside audio signal LW, the left upside audio signal LH, and the left-central-side audio signal LC. The second extended left audio signal may be any one of the surround back left audio signal SBL, the left outside audio signal LW, the left upside audio signal LH, and the left-central-side audio signal LC, and the channel of the second extended left audio signal may be different from that of the first extended left audio signal. The third extended left audio signal may be any one of the surround back left audio signal SBL, the left outside audio signal LW, the left upside audio signal LH, and the left-central-side audio signal LC, and the channel of the third extended left audio signal may be different from that of each of the first extended left audio signal and the second extended left audio signal.

Similarly the first extended right audio signal may be any one of the surround back right audio signal SBR, the right outside audio signal RW, the right upside audio signal RH, and the right-central-side audio signal RC. The second extended right audio signal may be any one of the surround back right audio signal SBR, the right outside audio signal RW, the right upside audio signal RH, and the right-central-side audio signal RC, and the channel of the second extended right audio signal may be different from that of the first extended right audio signal. The third extended right audio signal may be any one of the surround back right audio signal SBR, the right outside audio signal RW, the right upside audio signal RH, and the right-central-side audio signal RC, and the channel of the third extended right audio signal may be different from that of each of the first extended left audio signal and the second extended left audio signal.

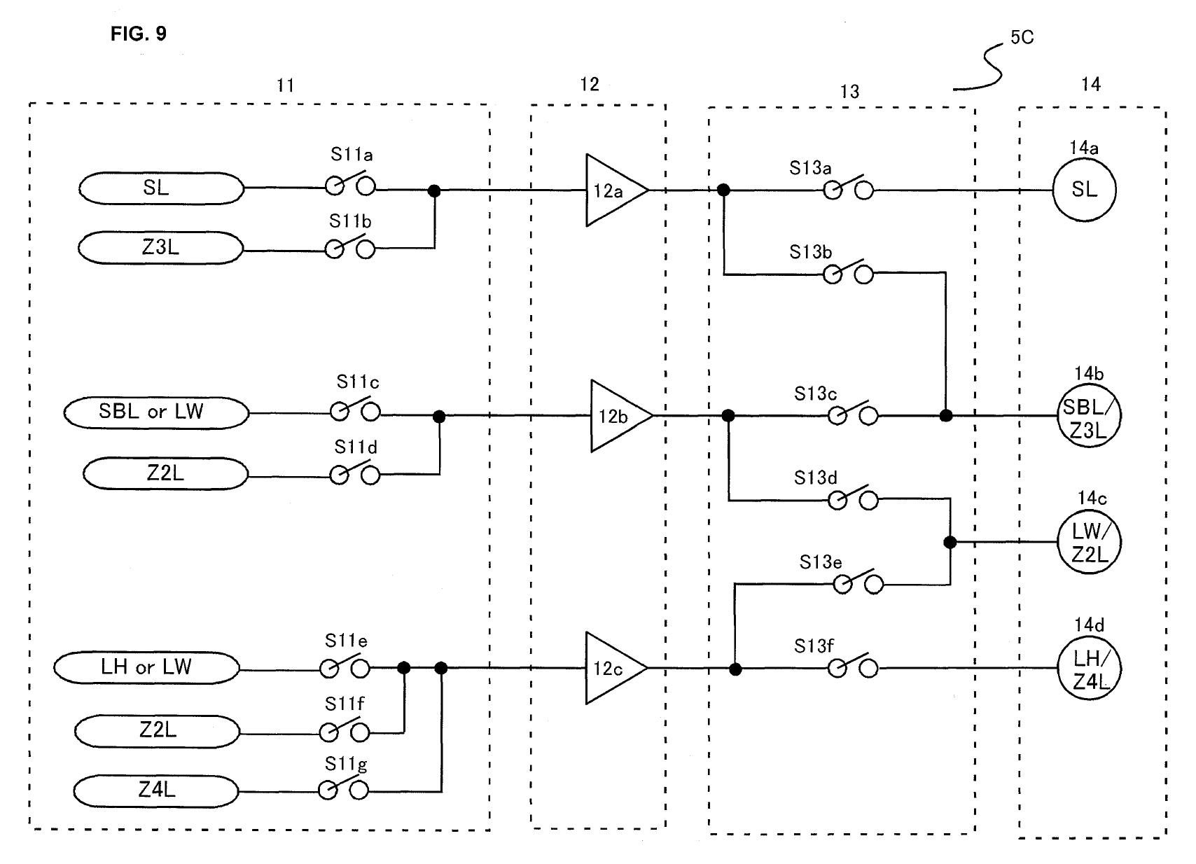

As illustrated in FIG. 9, the ZONE3 left audio signal Z3L and the ZONE4 left audio signal Z4L may be exchanged for one another. That is, the numerical characters of ZONE2, ZONE3, and ZONE4 have no particular meaning, but the numerical characters are added for the sake of convenience. Therefore, it is noted that a modification or a change in which the numerical characters are exchanged for each other is included in the scope of the present invention.

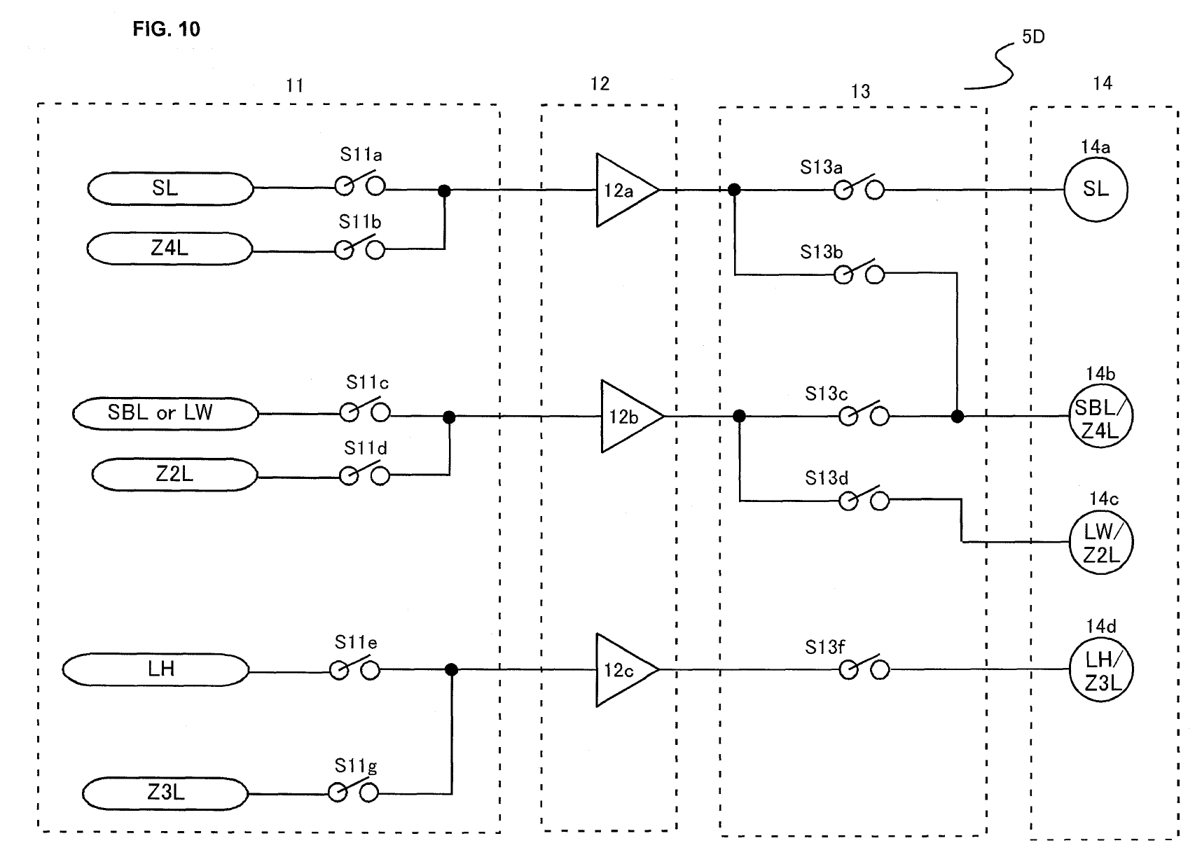

As illustrated in FIG. 10, the switches S11f and S13e may be omitted in the configuration in FIG. 5. In this case, although the surround back left audio signal SBL and the left outside audio signal LW (or the ZONE2 left audio signal Z2L) cannot simultaneously be played back, advantageously it is not necessary to release the connection of the surround speaker SSL to the surround left SP terminal 14a in the case that the ZONE4 left audio signal Z4L is played back.

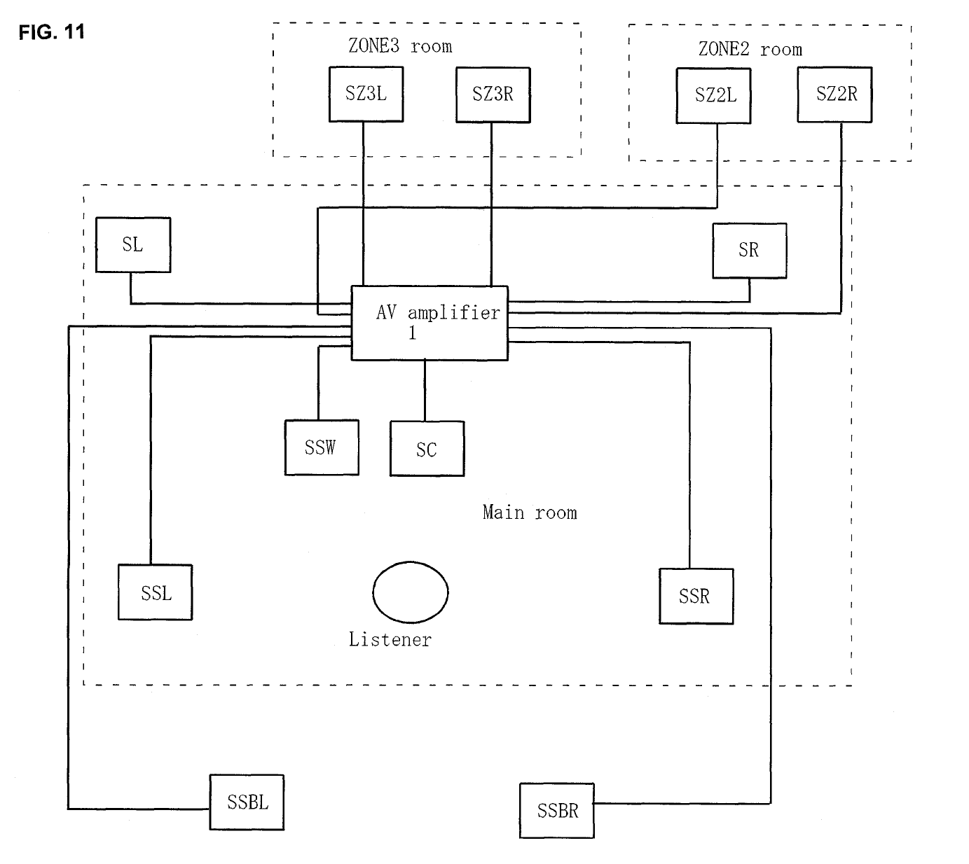

A third embodiment of the present invention will be described below. FIG. 11 illustrates a state in which the ZONE2 left speaker SZ2L, the ZONE2 right speaker SZ2R, the ZONE3 left speaker SZ3L, and the ZONE3 right speaker SZ3R are connected instead of the left upside speaker SLH, the right upside speaker SRH, the left outside speaker SLW, and the right outside speaker SRW in FIG. 1.

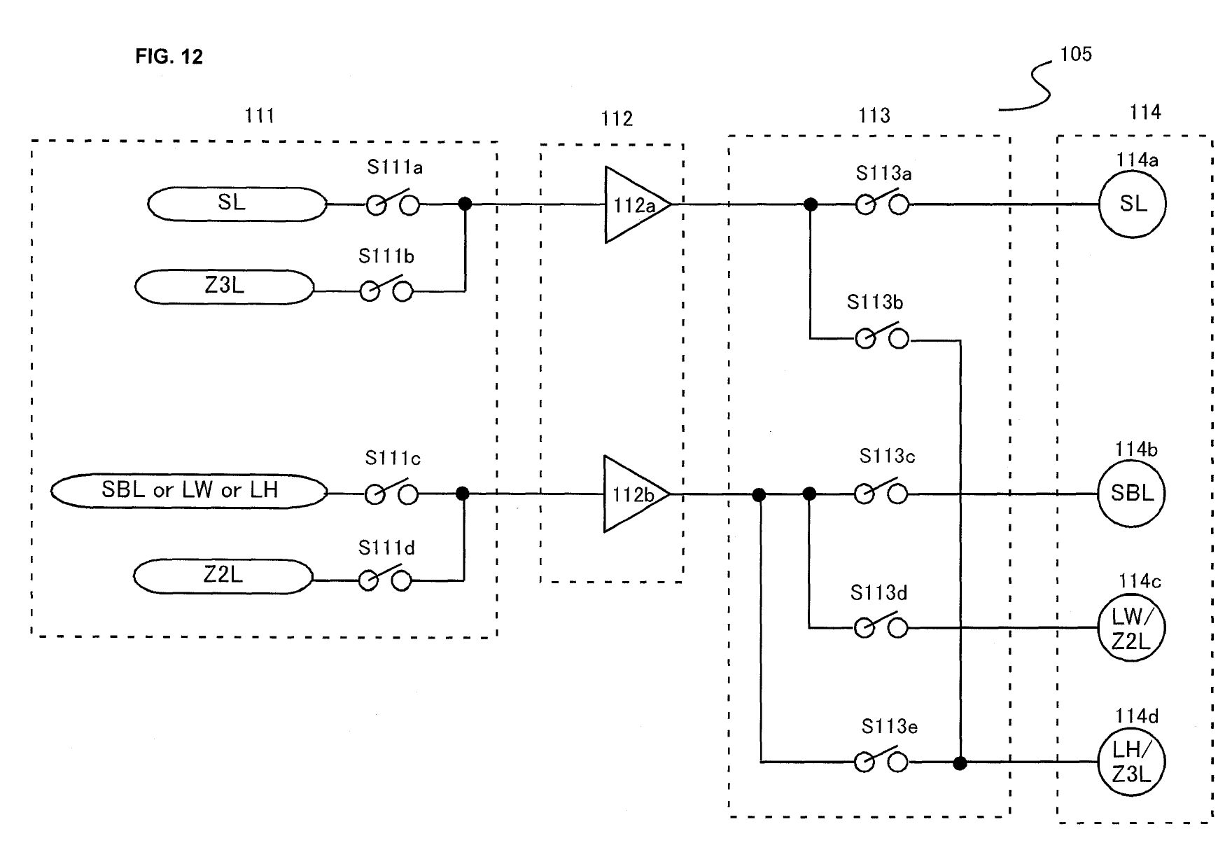

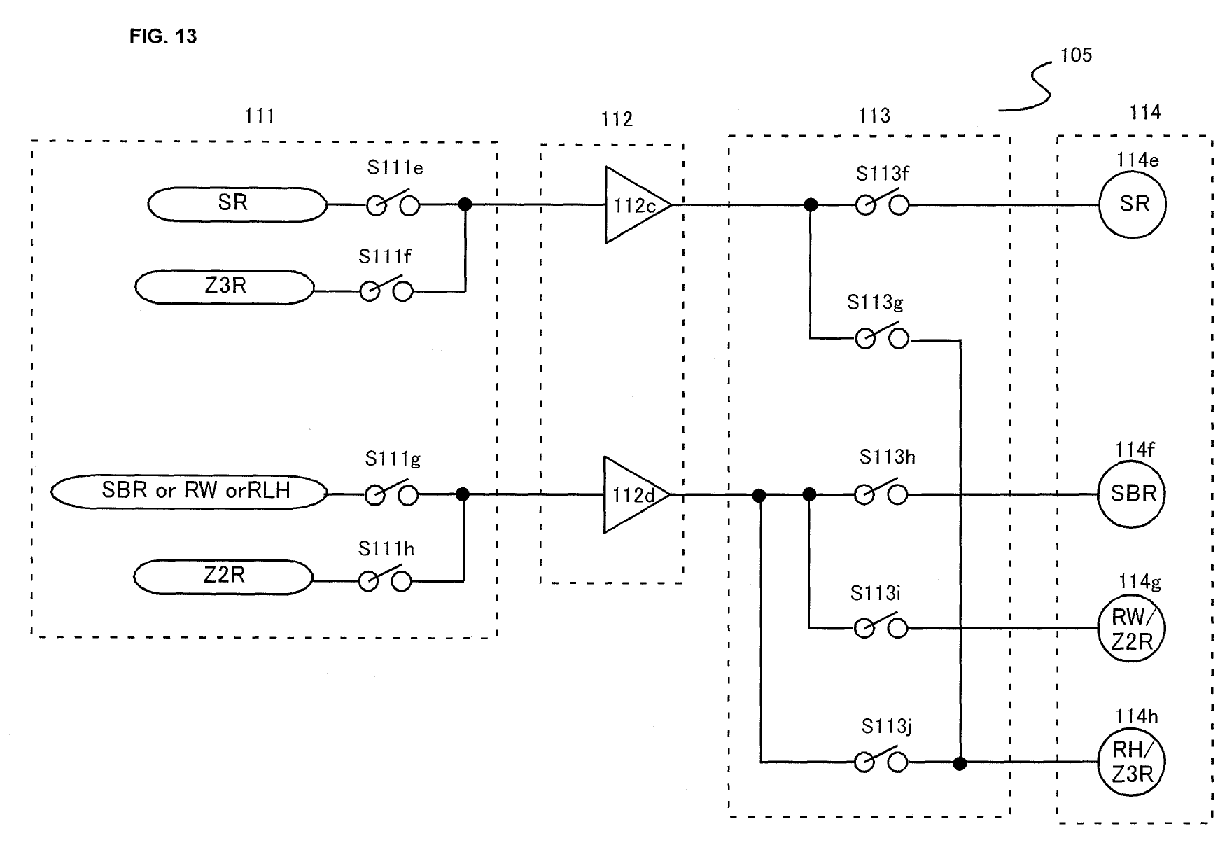

FIGS. 12 and 13 are block diagrams illustrating a main part of an audio processing unit 105 of the third embodiment. FIG. 12 illustrates a configuration of the left channel, and FIG. 13 illustrates a configuration of the right channel. The audio processing unit 105 includes a front-stage SP (speaker) relay 111, a power amplifier 112, a latter-stage SP (speaker) relay 113, and a SP (speaker) terminal 114. In FIGS. 12 and 13, because the circuits related to the 3.1 channels (the left audio signal L, the right audio signal R, the central audio signal C, and the low-frequency audio signal SW) in the basic 5.1 channels are identical to those of the related art, the circuits are omitted. The DSP provided at the front-stage of the front-stage SP relay 111 is also omitted.

The DSP decodes the multichannel audio data supplied from the HDMI receiver 3, and generates the audio data of each channel. The generated audio data is supplied to the front-stage SP relay 111.

The front-stage SP relay 111 includes switches S111a to S111h. On-off control is performed to each switch in response to an instruction from the controller 2.

The switch S111a switches whether the surround left audio signal SL input from the DSP is supplied to an amplifier 112a. The switch S111b switches whether the ZONE3 left audio signal Z3L supplied from the DSP is supplied to the amplifier 112a. The switch S111c switches whether the surround back left audio signal SBL, the left outside audio signal LW or the left upside audio signal LH, which is input from the DSP, is supplied to an amplifier 112b. The switch S111d switches whether the ZONE2 left audio signal Z2L supplied from the DSP is supplied to the amplifier 112b.

The switch S111e switches whether the surround right audio signal SR input from the DSP is supplied to an amplifier 112c. The switch S111f switches whether the ZONE3 right audio signal Z3R supplied from the DSP is supplied to the amplifier 112c. The switch S111g switches whether the surround back right audio signal SBR, the right outside audio signal RW or the right upside audio signal RH, which is input from the DSP, is supplied to an amplifier 112d. The switch S111h switches whether the ZONE2 right audio signal Z2R supplied from the DSP is supplied to the amplifier 112d.

The power amplifier 112 includes the amplifiers 112a to 112d. The amplifier 112a amplifies the surround left audio signal SL supplied from the switch S111a, and supplies the surround left audio signal SL to the latter-stage SP relay 113 (a switch S113a). Alternatively, the amplifier 112a amplifies the ZONE3 left audio signal Z3L supplied from the switch S111b, and supplies the ZONE3 left audio signal Z3L to the latter-stage SP relay 113 (a switch S113b). The amplifier 112b amplifies the surround back left audio signal SBL supplied from the switch S111c, and supplies the surround back left audio signal SBL to the latter-stage SP relay 113 (a switch S113c). Alternatively, the amplifier 112b amplifies the left outside audio signal LW supplied from the switch S111c or the ZONE2 left audio signal Z2L supplied from the switch S111d, and supplies the left outside audio signal LW or the ZONE2 left audio signal Z2L to the latter-stage SP relay 113 (switch S113d). Alternatively, the amplifier 112b amplifies the left upside audio signal LH supplied from the switch S111c, and supplies the left upside audio signal LH to the latter-stage SP relay 113 (a switch S113e).

The amplifier 112c amplifies the surround right audio signal SR supplied from the switch S111e, and supplies the surround right audio signal SR to the latter-stage SP relay 113 (a switch S113f). Alternatively, the amplifier 112c amplifies the ZONE3 right audio signal Z3R supplied from the switch S111f, and supplies the ZONE3 right audio signal Z3R to the latter-stage SP relay 113 (a switch S113g). The amplifier 112d amplifies the surround back right audio signal SBR supplied from the switch S111g, and supplies the surround back right audio signal SBR to the latter-stage SP relay 113 (a switch S113h). Alternatively, the amplifier 112d amplifies the right outside audio signal RW supplied from the switch S111g or the ZONE2 right audio signal Z2R supplied from the switch S111h, and supplies the right outside audio signal RW or the ZONE2 right audio signal Z2R to the latter-stage SP relay 113 (a switch S113i). Alternatively, the amplifier 112d amplifies the right upside audio signal RH supplied from the switch S111g, and supplies the right upside audio signal RH to the latter-stage SP relay 113 (a switch S113j).

The latter-stage SP relay 113 includes relay switches (hereinafter referred to as switches) S113a to S113j. The on-off control is performed to each switch in response to the instruction from the controller 2.

The switch S113a switches whether the surround left audio signal SL supplied from the amplifier 112a is supplied to a surround left SP terminal 114a. The switch S113b switches whether the ZONE3 left audio signal Z3L supplied from the amplifier 112a is supplied to a left upside/ZONE3 left SP terminal 114d. The switch S113c switches whether the surround back left audio signal SBL supplied from the amplifier 112b is supplied to a surround back left SP terminal 114b. The switch S113d switches whether the left outside audio signal LW or the ZONE2 left audio signal Z2L, which is supplied from the amplifier 112b, is supplied to a left outside/ZONE2 left SP terminal 114c. The switch S113e switches whether the left upside audio signal LH supplied from the amplifier 112b is supplied to the left upside/ZONE3 left SP terminal 114d.

The switch S113f switches whether the surround right audio signal SR supplied from the amplifier 112c is supplied to a surround right SP terminal 114e. The switch S113g switches whether the ZONE3 right audio signal Z3R supplied from the amplifier 112c is supplied to a right upside/ZONE3 right SP terminal 114h. The switch S113h switches whether the surround back right audio signal SBR supplied from the amplifier 112d is supplied to a surround back right SP terminal 114f. The switch S113i switches whether the right outside audio signal RW or the ZONE2 right audio signal Z2R, which is supplied from the amplifier 112d, is supplied to a right outside/ZONE2 right SP terminal 114g. The switch S113j switches whether the right upside audio signal RH supplied from the amplifier 112d is supplied to the right upside/ZONE3 right SP terminal 114h.

The SP terminal 114 includes the SP terminals 114a to 114h. The surround left speaker SSL is connected to the surround left SP terminal 114a. The surround back left speaker SSBL is connected to the surround back left SP terminal 114b. The left outside speaker SLW or the ZONE2 left speaker SZ2L is connected to the left outside/ZONE2 left SP terminal 114c. The left upside speaker SLH or the ZONE3 left speaker SZ3L is connected to the left upside/ZONE3 left SP terminal 114d.

The surround right speaker SSR is connected to the surround right SP terminal 114e. The surround back right speaker SSBR is connected to the surround back right SP terminal 114f. The right outside speaker SRW or the ZONE2 right speaker SZ2R is connected to the right outside/ZONE2 right SP terminal 114g. The right upside speaker SRH or the ZONE3 right speaker SZ3R is connected to the right upside/ZONE3 right SP terminal 114h.

An operation of the third embodiment will be described below.

(In the Case that the Surround Left Audio Signal SL and the Surround Right Audio Signal SR are Played Back)

When determining that the multichannel audio data includes the surround left audio signal SL, the controller 2 controls the switches S111a and S113a in the on state, and controls the switches S111b and S113b in the off state. Accordingly, the surround left audio signal SL is supplied from the DSP to the amplifier 112a through the switch S111a, amplified by the amplifier 112a, and supplied to the surround left SP terminal 114a through the switch S113a.

When determining that the multichannel audio data includes the surround right audio signal SR, the controller 2 controls the switches S111e and S113f in the on state, and controls the switches S111f and S113g in the off state. Accordingly, the surround right audio signal SR is supplied from the DSP to the amplifier 112c through the switch S111e, amplified by the amplifier 112c, and supplied to the surround right SP terminal 114e through the switch S113f.

(In the Case that the Surround Back Left Audio Signal SBL and The Surround Back Right Audio Signal SBR are Played Back)

When determining that the multichannel audio data includes the surround back left audio signal SBL, the controller 2 controls the switches S111c and S113c in the on state, and controls the switches S111d, S113d, and S113e in the off state. Accordingly, the surround back left audio signal SBL is supplied from the DSP to the amplifier 112b through the switch S111c, amplified by the amplifier 112b, and supplied to the surround back left SP terminal 114b through the switch S113c.

When determining that the multichannel audio data includes the surround back right audio signal SBR, the controller 2 controls the switches S111g and S113h in the on state, and controls the switches S111h, S113i, and S113j in the off state. Accordingly, the surround back right audio signal SBR is supplied from the DSP to the amplifier 112d through the switch S111g, amplified by the amplifier 112d, and supplied to the surround back right SP terminal 114f through the switch S113h.

(In the Case that the Left Outside Audio Signal LW and the Right Outside Audio Signal RW are Played Back)

When determining that the multichannel audio data includes the left outside audio signal LW, the controller 2 controls the switches S111c and S113d in the on state, and controls the switches S111d, S113c, and 113e in the off state. Accordingly, the left outside audio signal LW is supplied from the DSP to the amplifier 112b through the switch S111c, amplified by the amplifier 112b, and supplied to the left outside/ZONE2 left SP terminal 114c through the switch S113d.

When determining that the multichannel audio data includes the right outside audio signal RW, the controller 2 controls the switches S111g and S113i in the on state, and controls the switches S111h, S113h, and S113j in the off state. Accordingly, the right outside audio signal RW is supplied from the DSP to the amplifier 112d through the switch S111g, amplified by the amplifier 112d, and supplied to the right outside/ZONE2 right SP terminal 114g through the switch S113i.

(In the Case that the Left Upside Audio Signal LH and the Right Upside Audio Signal RH are Played Back)

When determining that the multichannel audio data includes the left upside audio signal LH, the controller 2 controls the switches S111c and S113e in the on state, and controls the switches S111d, S113c, and 113d in the off state. Accordingly, the left upside audio signal LH is supplied from the DSP to the amplifier 112b through the switch S111c, amplified by the amplifier 112b, and supplied to the left upside/ZONE3 left SP terminal 114d through the switch S113e.

When determining that the multichannel audio data includes the right upside audio signal RH, the controller 2 controls the switches S111g and S113j in the on state, and controls the switches S111h, S113h, and S113i in the off state. Accordingly, the right upside audio signal RH is supplied from the DSP to the amplifier 112d through the switch S111g, amplified by the amplifier 112d, and supplied to the right upside/ZONE3 right SP terminal 114h through the switch S113j.

(In the Case that the ZONE3 Left Audio Signal Z3L and the ZONE3 Right Audio Signal Z3R are Played Back)

When determining that the playback of the ZONE3 left audio signal Z3L is set by the user manipulation, the controller 2 controls the switches S111b and S113b in the on state, and controls the switches S111a, S113a, and S113e in the off state. Accordingly, the ZONE3 left audio signal Z3L is supplied from the DSP to the amplifier 112a through the switch S111b, amplified by the amplifier 112a, and supplied to the left upside/ZONE3 left SP terminal 114d through the switch S113b.

When determining that the playback of the ZONE3 right audio signal Z3R is set by the user manipulation, the controller 2 controls the switches S111f and S113g in the on state, and controls the switches S111e, S113f, and S113j in the off state. Accordingly, the ZONE3 right audio signal Z3R is supplied from the DSP to the amplifier 112c through the switch S111f, amplified by the amplifier 112c, and supplied to the right upside/ZONE3 right SP terminal 114h through the switch S113g.

As described above, although the ZONE3 left audio signal Z3L and the surround left audio signal SL cannot simultaneously be played back, the ZONE3 left audio signal Z3L is output from not the surround left SP terminal 114a but the left upside/ZONE3 left SP terminal 114d. That is, the surround left SP terminal 114a is the dedicated speaker terminal for playing back the surround left audio signal SL. Accordingly, in order to play back the ZONE3 left audio signal Z3L, it is not necessary to release the connection of the surround left speaker SSL having the high use frequency. Similarly, although the ZONE3 right audio signal Z3R and the surround right audio signal SR cannot simultaneously be played back, the ZONE3 right audio signal Z3R is output from not the surround right SP terminal 114e but the right upside/ZONE3 right SP terminal 114h. That is, the surround right SP terminal 114e is the dedicated speaker terminal for playing back the surround right audio signal SR. Accordingly, in order to play back the ZONE3 right audio signal Z3R, it is not necessary to release the connection of the surround right speaker SSR having the high use frequency.

The ZONE2 left audio signal Z2L (or the left outside audio signal LW) can be played back while the ZONE3 left audio signal Z3L is played back. Similarly the ZONE2 right audio signal Z2R (or the right outside audio signal RW) can be played back while the ZONE3 right audio signal Z3R is played back.

(In the Case that the ZONE2 Left Audio Signal Z2L and the ZONE2 Right Audio Signal Z2R are Played Back)

When determining that the playback of the ZONE2 left audio signal Z2L is set by the user manipulation, the controller 2 controls the switches S111d and S113d in the on state, and controls the switches S111c, S113c, and S113e in the off state. Accordingly, the ZONE2 left audio signal Z2L is supplied from the DSP to the amplifier 112b through the switch S111d, amplified by the amplifier 112b, and supplied to the left outside/ZONE2 left SP terminal 114c through the switch S113d.

When determining that the playback of the ZONE2 right audio signal Z2R is set by the user manipulation, the controller 2 controls the switches S111h and S113i in the on state, and controls the switches S111g, S113h, and S113j in the off state. Accordingly, the ZONE2 right audio signal Z2R is supplied from the DSP to the amplifier 112d through the switch S111h, amplified by the amplifier 112d, and supplied to the right outside/ZONE2 right SP terminal 114g through the switch S113i.

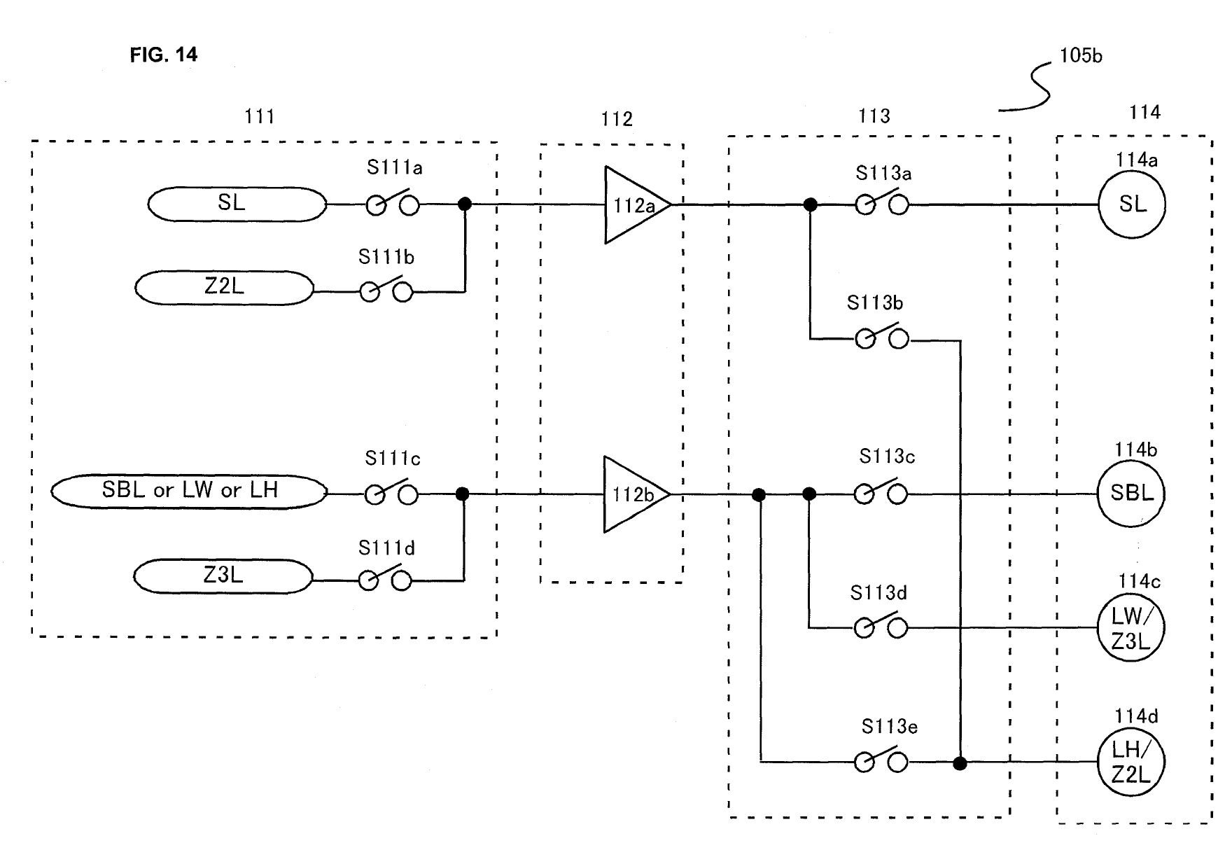

As illustrated in FIG. 14, the ZONE2 left audio signal Z2L and the ZONE3 left audio signal Z3L may be exchanged for each other. That is, the numerical characters of ZONE2 and ZONE3 have no particular meaning, but the numerical characters are added for the sake of convenience. Therefore, it is noted that a modification or a change in which the numerical characters are exchanged for each other is included in the scope of the present invention. The surround back left audio signal SBL, the left outside audio signal LW, and the left upside audio signal LH may be exchanged for one another.

The embodiments of the present invention are described above, the present invention is not limited to the embodiments. A program that makes a computer to execute the operation of the AV amplifier and a recording medium in which the program is recorded may be provided.

The present invention is suitably applied to the AV amplifier and the like.

What is claimed is:

1. An audio processing apparatus comprising: a first amplifier that amplifies a surround audio signal or a fourth room audio signal, the surround audio signal being a surround left audio signal or a surround right audio signal, and the fourth room audio signal being a fourth room left audio signal or a fourth room right audio signal; a second amplifier; a third amplifier; a first speaker terminal that outputs the surround audio signal; a second speaker terminal that outputs a first extended audio signal or the fourth room audio signal, the first extended audio signal being a first extended left audio signal or a first extended right audio signal; a third speaker terminal that outputs a second extended audio signal or a second room audio signal, the second extended audio signal being a second extended left audio signal or a second extended right audio signal, and the second room audio signal being a second room left audio signal or a second room right audio signal; a fourth speaker terminal that outputs a third extended audio signal or a third room audio signal, the third extended audio signal being a third extended left audio signal or a third extended right audio signal, and the third room audio signal being a third room left audio signal or a third room right audio signal; a first switch that switches whether the surround audio signal from the first amplifier is supplied to the first speaker terminal; a second switch that switches whether the fourth room audio signal from the first amplifier is supplied to the second speaker terminal; a third switch that switches whether the amplified first extended audio signal is supplied to the second speaker terminal; a fourth switch that switches whether the amplified second extended audio signal or the amplified second room audio signal is supplied to the third speaker terminal; a fifth switch that switches whether the amplified third extended audio signal or the amplified third room audio signal is supplied to the fourth speaker terminal; and a switching controller that controls the first switch, the second switch, the third switch, the fourth switch, and the fifth switch.

2. An audio processing apparatus comprising: a first amplifier that amplifies a surround audio signal or a third room audio signal, the surround audio signal being a surround left audio signal or a surround right audio signal, and the third room audio signal being a third room left audio signal or a third room right audio signal; a second amplifier that amplifies a first extended audio signal, a second extended audio signal, a third extended audio signal, or a second room audio signal, the first extended audio signal being a first extended left audio signal or a first extended right audio signal, the second extended audio signal being a second extended left audio signal or a second extended right audio signal, the third extended audio signal being a third extended left audio signal or a third extended right audio signal, and the second room audio signal being a second room left audio signal or a second room right audio signal; a first speaker terminal that outputs the surround audio signal; a second speaker terminal that outputs the first extended audio signal; a third speaker terminal that outputs the second extended audio signal or the second room audio signal; a fourth speaker terminal that outputs the third extended audio signal or the third room audio signal; a first switch that switches whether the surround audio signal from the first amplifier is supplied to the first speaker terminal; a second switch that switches whether the third room audio signal from the first amplifier is supplied to the fourth speaker terminal; a third switch that switches whether the first extended audio signal from the second amplifier is supplied to the second speaker terminal; a fourth switch that switches whether the second extended audio signal or the second room audio signal from the second amplifier is supplied to the third speaker terminal; a fifth switch that switches whether the third extended audio signal from the second amplifier is supplied to the fourth speaker terminal; and a switching controller that controls the first switch, the second switch, the third switch, the fourth switch, and the fifth switch.

3. The audio processing apparatus according to claim 1, wherein the first extended left audio signal is any one of a surround back left audio signal, a left outside audio signal, a left upside audio signal, and a left-central-side audio signal, the first extended right audio signal is any one of a surround back right audio signal, a right outside audio signal, a right upside audio signal, and a right-central-side audio signal, the second extended left audio signal is any one of the surround back left audio signal, the left outside audio signal, the left upside audio signal, and the left-central-side audio signal and is different from the first extended left audio signal, the second extended right audio signal is any one of the surround back right audio signal, the right outside audio signal, the right upside audio signal, and the right-central-side audio signal and different from the first extended right audio signal, the third extended left audio signal is any one of the surround back left audio signal, the left outside audio signal, the left upside audio signal, and the left-central-side audio signal and different from the first extended left audio signal and the second extended left audio signal, and the third extended right audio signal is any one of the surround back right audio signal, the right outside audio signal, the right upside audio signal, and the right-central-side audio signal and different from the first extended right audio signal and the second extended right audio signal.
